(19) United States
(12) Patent Application Publication
(10) Pub. No.: US 2026/0353128 A1
(43) Pub. Date: Nov. 5, 2026

(54) METHOD, DEVICE AND SYSTEM FOR WIRELESS SENSING

(71) Applicant: Huawei Technologies Co., Ltd., Shenzhen (CN)

(72) Inventors: Weibin Ma, Shenzhen (CN); Bo Ran, Shenzhen (CN); Hassan Aboubakr Omar, Ottawa (CA); M Zulfiker Ali, Scarborough (CA)

(21) Appl. No.: 19/714,970

(22) Filed: Jun. 22, 2026

Related U.S. Application Data
(63) Continuation of application No. PCT/CN2023/141304, filed on Dec. 23, 2023.

(51) Int. Cl. H04W 24/08; H04W 28/06

(52) U.S. Cl. CPC H04W 24/08; H04W 28/06

(57) ABSTRACT

A method for wireless sensing is provided. The method, performed by a first wireless sensing device, includes: sending a second wireless sensing data unit to a second wireless sensing device, values of receiving address and transmitting address fields in the second wireless sensing data unit being an address of the second wireless sensing device and an address of the first wireless sensing device, respectively; receiving a first wireless sensing data unit from the second wireless sensing device, values of the receiving address and transmitting address fields in the first wireless sensing data unit being the same as the values of the receiving address and transmitting address fields in the second wireless sensing data unit, respectively; and discarding the first wireless sensing data unit based on the value of the receiving address field in the first wireless sensing data unit.

### CROSS REFERENCE TO RELATED APPLICATIONS

This application is a continuation of International Patent Application No. PCT/CN2023/141304, filed Dec. 23, 2023, which is incorporated by reference herein in its entirety.

### TECHNICAL FIELD

The present disclosure relates to the field of wireless communication, and in particular, to method, device, system for wireless sensing, and computer readable storage medium.

### BACKGROUND

Wireless sensing is an emerging technology that enables a wide range of applications, such as gesture recognition for human-computer interaction, vital signs monitoring for health care, and intrusion detection for security management.

Wireless sensing technology analyzes the changes in wireless signals during propagation to obtain information (e.g., channel measurements) that characterizes the environment, thus achieving scene perception, such as ranging, speed measurement, positioning, target tracking, etc. The measurement of channel characteristics is also referred to as channel state information (CSI). In a wireless system, a transmitting end sends a signal, which is received by a receiving end through a wireless channel, and the receiving end processes the received signal to obtain the CSI, thus achieving the sensing of the surrounding environment.

### SUMMARY

Embodiments of the present disclosure provide a method, device, system for wireless sensing to protect privacy in wireless sensing environments.

In a first aspect, a method for wireless sensing is provided. The method is performed by a first wireless sensing device. The method includes: sending a second wireless sensing data unit to a second wireless sensing device, wherein a value of a receiving address field in the second wireless sensing data unit is an address of the second wireless sensing device, and a value of a transmitting address field in the second wireless sensing data unit is an address of the first wireless sensing device; receiving a first wireless sensing data unit from the second wireless sensing device, wherein a value of the receiving address field and a value of the transmitting address field in the first wireless sensing data unit are the same as the value of the receiving address field and the value of the transmitting address field in the second wireless sensing data unit, respectively; and discarding the first wireless sensing data unit based on the value of the receiving address field in the first wireless sensing data unit.

In the embodiments of the present disclosure, since the value of the receiving address field and the value of the transmitting address field in the first wireless sensing data unit are respectively the same as the value of the receiving address field and the value of the transmitting address field in the second wireless sensing data unit, an eavesdropper may mistakenly understand that the two wireless sensing data units are transmitted by the same sensing transmitter, and the eavesdropper will process the wireless sensing data units to implement a wireless sensing application. In this way, the wireless sensing application on the eavesdropper may not be implemented to violate the privacy of legitimate wireless sensing users, which decreases the ability of the eavesdropper to implement a useful wireless sensing application, and in turn protect the privacy of legitimate wireless sensing users.

In a second aspect, a method for wireless sensing is provided. The method is performed by a second wireless sensing device. The method includes: receiving a second wireless sensing data unit from a first wireless sensing device, wherein a value of a receiving address field in the second wireless sensing data unit is an address of the second wireless sensing device, and a value of a transmitting address field in the second wireless sensing data unit is an address of the first wireless sensing device; and sending a first wireless sensing data unit, wherein a value of the receiving address field and a value of the transmitting address field in the first wireless sensing data unit are the same as the value of the receiving address field and the value of the transmitting address field in the second wireless sensing data unit, respectively.

The advantages brought by the second aspect can be referred to the first aspect, which will not be detailed here.

In some embodiments, a first value of a field for channel state information (CSI) estimation in the first wireless sensing data unit is different from a second value of the field for the CSI estimation in the second wireless sensing data unit. In this way, the sequence of channel estimations performed by the eavesdropper based on the first and second values may be corrupted, thus preventing the eavesdropper from estimating a sequence of actual channel information and protecting the privacy of legitimate wireless sensing users.

In some embodiments, the first value is determined based on a first parameter, and the first parameter is used to influence a value of a baseband signal for the CSI estimation; and the second value is determined based on a predefined second parameter that is used to obtain the baseband signal, and the second parameter is different from the first parameter. In this way, the sequence of channel estimations performed by the eavesdropper based on the first and second values may be corrupted, thus preventing the eavesdropper from estimating a sequence of actual channel information and protecting the privacy of legitimate wireless sensing users.

In some embodiments, the first parameter includes a first random spatial mapping matrix and/or a first random channel estimation sequence; and the second parameter includes a second spatial mapping matrix that is different from the first spatial mapping matrix and/or a second channel estimation sequence that is different from the first channel estimation sequence. In this way, the first value determined based on the first spatial mapping matrix and/or the first channel estimation sequence is randomized compared with the second value determined based on the second spatial mapping matrix and/or the second channel estimation sequence, thus preventing the eavesdropper from estimating the actual channel information.

In some embodiments, the first wireless sensing data unit is transmitted by the second wireless sensing device via a set of second antennas with a second antenna radiation pattern that is selected from a set of radiation patterns; and the second wireless sensing data unit is transmitted by the first wireless sensing device via a set of first antennas with a predefined first antenna radiation pattern. In this way, the eavesdropper cannot identify the first and second wireless sensing data units, and the sequence of channel estimations performed by the eavesdropper based on the first and second values may be corrupted, thus preventing the eavesdropper from estimating a sequence of actual channel information and protecting the privacy of legitimate wireless sensing users.

In some embodiments, the first wireless sensing device is a sensing initiator initiating a sensing procedure, and the second wireless sensing device is a sensing responder participating in the sensing procedure; or the second wireless sensing device is the sensing initiator initiating the sensing procedure, and the first wireless sensing device is the sensing responder participating in the sensing procedure.

In a third aspect, a method for wireless sensing is provided. The method is performed by a first wireless sensing device. The method includes: sending a first wireless sensing data unit and a second wireless sensing data unit to a second wireless sensing device, wherein the first wireless sensing data unit is different from the second wireless sensing data unit, and the first wireless sensing data unit is used to result in a channel state information (CSI) estimation that is different from the CSI estimation from the second wireless sensing data unit; receiving channel characteristic information from the second wireless sensing device, wherein the channel characteristic information includes first CSI that is estimated based on the first wireless sensing data unit; and according to the corresponding relation between the first wireless sensing data unit and the first CSI, discarding the first CSI.

In the embodiments of the present disclosure, the eavesdropper obtains a sequence of first and second CSI, i.e., ‘fake’ and ‘actual’ channel estimations, so that the eavesdropping device cannot implement a wireless sensing application to detect actual information of the wireless sensing environment, which may decrease the ability of the eavesdropping device to implement a useful wireless sensing application, and in turn protect the privacy of legitimate wireless sensing users.

In some embodiments, the channel characteristic information further includes second CSI that is estimated based on the second wireless sensing data unit.

In a fourth aspect, a method for wireless sensing is provided. The method is performed by a second wireless sensing device. The method includes: receiving a first wireless sensing data unit and a second wireless sensing data unit from a first wireless sensing device, wherein the first wireless sensing data unit is different from the second wireless sensing data unit, and the first wireless sensing data unit is used to result in a channel state information (CSI) estimation that is different from the CSI estimation from the second wireless sensing data unit; obtaining first CSI based on the first wireless sensing data unit; obtaining second CSI based on the second wireless sensing data unit; and sending both the first CSI and the second CSI to the first wireless sensing device.

The advantages brought by the fourth aspect can be referred to the third aspect, which will not be detailed here.

In some embodiments, a first value of a field for channel state information (CSI) estimation in the first wireless sensing data unit is different from a second value of the field for the CSI estimation in the second wireless sensing data unit.

In some embodiments, the first value is determined based on a first parameter, and the first parameter is used to influence a value of a baseband signal for the CSI estimation; and the second value is determined based on a predefined second parameter that is used to obtain the baseband signal, and the second parameter is different from the first parameter.

In some embodiments, the first parameter includes a first random spatial mapping matrix and/or a first random channel estimation sequence; and the second parameter includes a second spatial mapping matrix that is different from the first spatial mapping matrix and/or a second channel estimation sequence that is different from the first channel estimation sequence.

In some embodiments, the first wireless sensing data unit is transmitted by the first wireless sensing device via a set of first antennas with a second antenna radiation pattern that is selected from a set of radiation patterns; and the second wireless sensing data unit is transmitted by the first wireless sensing device via the set of first antennas with a predefined first antenna radiation pattern that is different from the second antenna radiation pattern.

In some embodiments, the first wireless sensing device is a sensing initiator initiating a sensing procedure, and the second wireless sensing device is a sensing responder participating in the sensing procedure.

In a fifth aspect, a method for wireless sensing is provided. The method is performed by a first wireless sensing device. The method includes: generating a plurality of wireless sensing data units; and sending the plurality of wireless sensing data units to a second wireless sensing device, wherein each wireless sensing data unit of the plurality of wireless sensing data units includes an indication indicating whether the wireless sensing data unit is a first wireless sensing data unit or a second wireless sensing data unit.

In the embodiments of the present disclosure, the eavesdropper cannot discard first wireless sensing data units, and the wireless sensing application on the eavesdropper may not be implemented based on the sequence of first and second wireless sensing data units. Therefore, the ability of the eavesdropper to implement a useful wireless sensing application is decreased, and the privacy of legitimate wireless sensing users is protected.

In some embodiments, the indication is included in an encrypted data field in the MAC layer protocol data unit (MPDU) carried by the wireless sensing data unit. In this way, the eavesdropper cannot differentiate the first and second wireless sensing data unit, which decrease the ability of the eavesdropper to implement a useful wireless sensing application to protect the privacy.

In a sixth aspect, a method for wireless sensing is provided. The method is performed by a second wireless sensing device. The method includes: receiving a plurality of wireless sensing data units from a first wireless sensing device, wherein each wireless sensing data unit of the plurality of wireless sensing data units includes an indication indicating whether the wireless sensing data unit is a first wireless sensing data unit or a second wireless sensing data unit; and discarding the wireless sensing data unit if the indication of the wireless sensing data unit indicates that the wireless sensing data unit is the first wireless sensing data unit.

The advantages brought by the sixth aspect can be referred to the fifth aspect, which will not be detailed here.

In some embodiments, the first wireless sensing data unit is transmitted by the first wireless sensing device via a set of first antennas with a second antenna radiation pattern that is selected from a set of radiation patterns; and the second wireless sensing data unit is transmitted by the first wireless sensing device via the set of first antennas with a predefined first antenna radiation pattern that is different from the second antenna radiation pattern.

In some embodiments, a first value of a field for channel state information (CSI) estimation in the first wireless sensing data unit is different from a second value of a field for the CSI estimation in the second wireless sensing data unit.

In some embodiments, the first value is determined based on a first parameter, and the first parameter is used to influence a value of a baseband signal for the CSI estimation; and the second value is determined based on a predefined second parameter that is used to obtain the baseband signal, and the second parameter is different from the first parameter.

In some embodiments, the first parameter includes a first random spatial mapping matrix and/or a first random channel estimation sequence; and the second parameter includes a second spatial mapping matrix that is different from the first spatial mapping matrix and/or a second channel estimation sequence that is different from the first channel estimation sequence.

In some embodiments, the second wireless sensing device is a sensing initiator initiating a sensing procedure, and the first wireless sensing device is a sensing responder participating in the sensing procedure.

In some embodiments, the first wireless sensing device is a sensing transmitter, and the second wireless sensing device is a sensing receiver.

In a seventh aspect, a method for wireless sensing is provided. The method is performed by a first wireless sensing device. The method includes: generating an identification unit; and sending the identification unit to a second wireless sensing device, wherein the identification unit includes at least one first identification indicating a first sensing measurement exchange or at least one second identification indicating a second sensing measurement exchange; and the first wireless sensing device is a sensing initiator initiating a sensing procedure, and the second wireless sensing device is a sensing responder participating in the sensing procedure.

In the embodiments of the present disclosure, the eavesdropper cannot identify the first sensing measurement exchange and the second sensing measurement exchange, so that the wireless sensing application on the eavesdropper may not be implemented based on the sequence of wireless sensing data units transmitted in the first and second sensing measurement exchanges. As a result, the ability of the eavesdropper to implement a useful wireless sensing application is decreased, and the privacy of legitimate wireless sensing users is protected.

In some embodiments, at least one wireless sensing data unit transmitted in the first sensing measurement exchange is a first wireless sensing data unit; and at least one wireless sensing data unit transmitted in the second sensing measurement exchange is a second wireless sensing data unit.

In an eighth aspect, a method for wireless sensing is provided. The method is performed by a second wireless sensing device. The method includes: receiving an identification unit from a first wireless sensing device, wherein the identification unit includes at least one first identification indicating a first sensing measurement exchange or a second identification indicating at least one second sensing measurement exchange; if a sensing measurement exchange is the first sensing measurement exchange, at least one wireless sensing data unit that is transmitted in the first sensing measurement exchange is a first wireless sensing data unit; and if the sensing measurement exchange is the second sensing measurement exchange, at least one wireless sensing data unit that is transmitted in the second sensing measurement exchange is a second wireless sensing data unit.

The advantages brought by the eighth aspect can be referred to the seventh aspect, which will not be detailed here.

In some embodiments, each identification in the identification unit is included in an encrypted data field in the identification unit.

In some embodiments, the first wireless sensing data unit or the second wireless sensing data unit is a PPDU carrying data or a null data PPDU.

In some embodiments, the data carried by the first wireless sensing data unit or the second wireless sensing data unit includes a trigger frame, a clear to send (CTS)-to-self frame, a null data packet (NDP) announcement frame, or a sensing measurement report frame.

In some embodiments, at least one first wireless sensing data unit transmitted by the first wireless sensing device in the first sensing measurement exchange carries a first identification indicating a first sensing measurement exchange, where the first identification is previously transmitted by the first wireless sensing device to the second wireless sensing device in a previous identification unit; and at least one second wireless sensing data unit transmitted by the first wireless sensing device in the second sensing measurement exchange carries a second identification indicating a second sensing measurement exchange, where the second identification is previously transmitted by the first wireless sensing device to the second wireless sensing device in a previous identification unit.

In some embodiments, the method further includes identifying whether a sensing measurement exchange is a first sensing measurement exchange or a second sensing measurement exchange based on the identification carried by the wireless sensing data unit transmitted by the first wireless sensing device.

In some embodiments, a first value of a field for channel state information (CSI) estimation in the first wireless sensing data unit is different from a second value of the field for the CSI estimation in the second wireless sensing data unit.

In some embodiments, the first value is determined based on a first parameter, and the first parameter is used to influence a value of a baseband signal for the CSI estimation; and the second value is determined based on a predefined second parameter that is used to obtain the baseband signal, and the second parameter is different from the first parameter.

In some embodiments, the first parameter includes a first random spatial mapping matrix and/or a first random channel estimation sequence; and the second parameter includes a second spatial mapping matrix that is different from the first spatial mapping matrix and/or a second channel estimation sequence that is different from the first channel estimation sequence.

In some embodiments, the first wireless sensing data unit is transmitted by the first wireless sensing device via a set of first antennas with a second antenna radiation pattern that is selected from a set of radiation patterns; and the second wireless sensing data unit is transmitted by the first wireless sensing device via the set of first antennas with a predefined first antenna radiation pattern that is different from the second antenna radiation pattern.

In some embodiments, the first wireless sensing data unit is transmitted by the second wireless sensing device via a set of second antennas with the second antenna radiation pattern that is selected from the set of radiation patterns; and the second wireless sensing data unit is transmitted by the second wireless sensing device via the set of second antennas with the predefined first antenna radiation pattern that is different from the second antenna radiation pattern.

In a ninth aspect, a wireless sensing system is provided. The wireless sensing system includes a first wireless sensing device and a second wireless sensing device that are communicated with each other. The first wireless sensing device is used to perform one or more steps of the method for wireless sensing as described in any one of the above aspects. The second wireless sensing device is used to perform one or more steps of the method for wireless sensing as described in any one of the above aspects.

In a tenth aspect, a first wireless sensing device is provided. The first wireless sensing device includes a processing module and a communication module. The processing module is used to process data units. The communication module is used to transmit and/or receive data units.

In an eleventh aspect, a second wireless sensing device is provided. The second wireless sensing device includes a processing module and a communication module. The processing module is used for processing data units. The communication module is used for transmitting and/or receiving data units.

In a twelfth aspect, a wireless sensing device is provided. The wireless sensing device includes at least one processor and a transceiver coupled to the at least one processor. The transceiver is used to receive and send signals, and the at least one processor is used to process signals.

In some embodiments, the wireless sensing device further includes a computer-readable memory having stored thereon program instructions that, when executed by the at least one processer, cause the wireless sensing device to implement one or more steps of the method for wireless sensing as described in any one of the above aspects.

In a thirteenth aspect, a computer-readable storage medium is provided. The computer-readable storage medium has stored thereon program instructions that, when executed by a wireless sensing device, cause the wireless sensing device to perform one or more steps of the method for wireless sensing as described in any one of the above aspects.

In a fourteenth aspect, a computer program product is provided. The computer program product includes program instructions that, when executed by a wireless sensing device, cause the wireless sensing device to perform one or more steps of the method for wireless sensing as described in any one of the above aspects.

The advantages brought by any design from the ninth to fourteenth aspects can be referred to the first to eighth aspects or the different designs of the first to eighth aspects, which will not be detailed here.

On the basis of the implementations provided in the above aspects, the present disclosure is able to provide more implementations by further combination.

### BRIEF DESCRIPTION OF THE DRAWINGS

FIG. 1 is an architectural diagram of a wireless sensing system provided in some embodiments of the present disclosure;

FIG. 2 is an architectural diagram of another wireless sensing system provided in some embodiments of the present disclosure;

FIG. 3 is a schematic diagram of a structure of a wireless sensing device provided in some embodiments of the present disclosure;

FIG. 4 is a schematic diagram of a sensing scenario in a home environment provided in some embodiments of the present disclosure;

FIG. 5 is a diagram of a physical layer protocol data unit (PPDU) format provided in some embodiments of the present disclosure;

FIG. 6 is a diagram of experimental testing results provided in some embodiments of the present disclosure;

FIG. 7 is a diagram of experimental testing results provided in some other embodiments of the present disclosure;

FIG. 8A is a diagram of antenna radiation patterns provided in some embodiments of the present disclosure;

FIG. 8B is a diagram of experimental testing results provided in some other embodiments of the present disclosure;

FIG. 9A is a flow diagram of a method for wireless sensing provided in some embodiments of the present disclosure;

FIG. 9B is a diagram of a wireless sensing scenario provided in some embodiments of the present disclosure;

FIG. 10A is a flow diagram of another method for wireless sensing provided in some embodiments of the present disclosure;

FIG. 10B is a diagram of another wireless sensing scenario provided in some embodiments of the present disclosure;

FIG. 11A is a flow diagram of yet another method for wireless sensing provided in some embodiments of the present disclosure;

FIG. 11B is a diagram of yet another wireless sensing scenario provided in some embodiments of the present disclosure;

FIG. 12A is a flow diagram of yet another method for wireless sensing provided in some embodiments of the present disclosure;

FIG. 12B is a diagram of a trigger-based (TB) sensing measurement exchange provided in some embodiments of the present disclosure;

FIG. 12C is a diagram of a non-TB sensing measurement exchange provided in some embodiments of the present disclosure;

FIG. 13 is a schematic structural diagram of a first wireless sensing device provided in some embodiments of the present disclosure; and

FIG. 14 is a schematic structural diagram of a second wireless sensing device provided in some embodiments of the present disclosure.

### DETAILED DESCRIPTION OF THE ILLUSTRATIVE EMBODIMENTS

Technical solutions in some embodiments of the present disclosure will be described clearly and completely with reference to the accompanying drawings below. However, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive meaning, i.e., “including, but not limited to”. In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

In the description of some embodiments, the term “connected” and its derivatives may be used. For example, the term “connected” may be used when describing some embodiments to indicate that two or more components are in direct physical contact or electrical contact with each other. However, the term “connected” or “communicatively connected” may also mean that two or more components are not in direct contact with each other but still cooperate or interact with each other. The embodiments disclosed herein are not necessarily limited to the content herein.

The term “and/or” merely describes an association of associated objects, which include three situations. For example, “A and/or B” refers to three situations: A alone, A and B, and B alone.

Hereinafter, the terms “first” and “second” are used for descriptive purposes only, and are not to be construed as indicating or implying the relative importance or implicitly indicating the number of indicated technical features. Thus, features defined with “first” and “second” may explicitly or implicitly include one or more of the features, and the terms “first” and “second” are not used to describe a specific order of the objects. For example, “the first sub-sentence group” and “the second sub-sentence group” are used for distinguishing different sub-sentence groups, rather than describing a specific order of the sub-sentence groups.

In the description of the embodiments of the present disclosure, the term “multiple”, “a plurality of” or “the plurality of” means two or more unless otherwise specified, and “multiple”, “a plurality of” or “the plurality of” may also be described as “at least two”.

As used herein, the term “if” is, optionally, construed as “when”, “in a case where”, “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

The use of the phrase “applicable to” or “configured to” herein means an open and inclusive language, which does not exclude devices that are applicable to or configured to perform additional tasks or steps.

In addition, the phrase “based on” used herein has an open and inclusive meaning, since a process, step, calculation or other action that is “based on” one or more of the stated conditions or values may, in practice, be based on additional conditions or values exceeding those stated.

As used herein, “at least one of: <a list of two or more elements>” and “at least one of <a list of two or more elements>” and similar wording, where the list of two or more elements is joined by “and” or “or”, indicate at least any one of the elements, or at least any two or more of the elements, or at least all the elements.

As used herein, the term “communication network” refers to a network following any suitable communication standards, such as Wi-Fi, New Radio (NR), Long Term Evolution (LTE), LTE-Advanced (LTE-A), Wideband Code Division Multiple Access (WCDMA), High-Speed Packet Access (HSPA), and Narrow Band Internet of Things (NB-IoT). Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a Wi-Fi AP, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some embodiments, a radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearables, a head-mounted display (HMD), a vehicle, a drone, a medical device and application (e.g., remote surgery), an industrial device and application (e.g., a robot and/or other wireless devices operating in an industrial and/or an automated processing chain context), a consumer electronics device, a device operating on commercial and/or industrial wireless networks, and the like. The terminal device may also correspond to a Mobile Termination (MT) part of an IAB node (e.g., a relay node).

Some technical terms involved in the embodiments of the present disclosure will be explained below.

Wireless sensing, namely sensing measurement, involves utilizing wireless communication technologies to remotely monitor environmental parameters. For example, amplitude and phase changes in the transmitted waveforms can be used to detect the motion of humans, pets, and objects. Advanced signal processing and artificial intelligence (AI)/machine learning (ML) algorithms enable these systems to accurately detect the presence and movements without the need for specialized hardware. Wireless sensing aims to provide several advantages compared to conventional sensor networks, such as non-intrusiveness, wide coverage, low power consumption, accurate tracking, cost-effectiveness, and a privacy-friendly nature. Wireless sensing (e.g., wireless local area network (WLAN) sensing or Wi-Fi sensing) uses wireless networks to sense presence, range, velocity, and location of objects in various environments through subtle changes in the communication channel. Wi-Fi sensing is the use of physical (PHY) layer and medium access control (MAC) layer features of a Wi-Fi station (STA) to obtain information (e.g., channel measurements) that characterizes the environment in which the STA operates. The information obtained with Wi-Fi sensing can be employed to enable monitoring-, recognition-, or detection-based applications. These applications are mainly developed based on a sequence of measurements of some characteristics of the wireless channel between a transmitting STA and receiving STA, which are referred to as a sensing transmitter and sensing receiver, respectively. The measurement of channel characteristics, referred to as channel state information (CSI), can be performed by a sensing receiver via the transmission of a PHY layer protocol data unit (PPDU), referred to as a sensing PPDU, by a sensing transmitter.

Sensing initiator, the sensing initiator is a device (e.g., a node, an STA, or an access point (AP)) that initiates a sensing procedure. For example, the sensing initiator is the node at which a sensing application is implemented.

Sensing responder, the sensing responder is a device (e.g., a node, an STA, or an AP) that participates in a sensing procedure initiated by a sensing initiator.

Sensing transmitter, the sensing transmitter is a device (e.g., a node, an STA, or an AP) that transmits sensing signals (e.g., PPDUs) for wireless sensing in a sensing procedure.

Sensing receiver, the sensing receiver is a device (e.g., a node, an STA, or an AP) that receives sensing signals transmitted by the sensing transmitter and performs sensing measurement in a sensing procedure. For example, the sensing receiver is the intended receiver of actual sensing signals transmitted by the sensing transmitter.

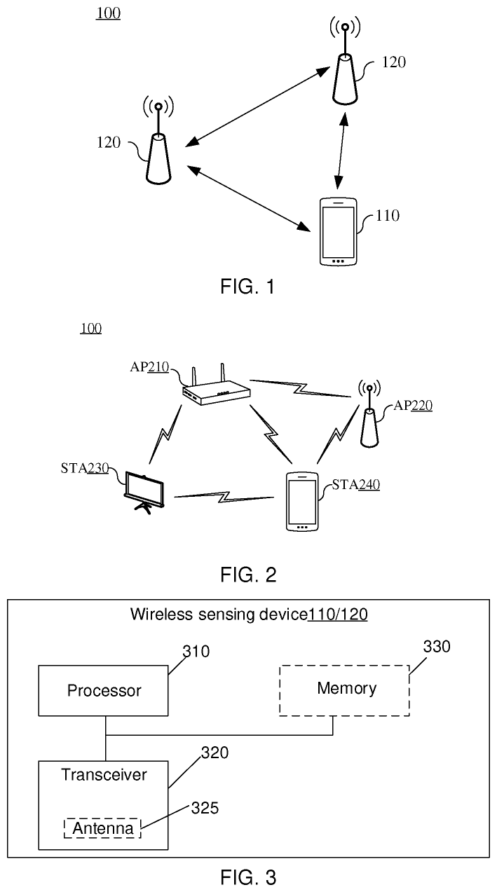

FIG. 1 shows an architecture of a wireless sensing system provided in some embodiments of the present disclosure. As shown in FIG. 1, some embodiments of the present disclosure provide a wireless sensing system 100, the wireless sensing system 100 includes a first wireless sensing device 110 and a second wireless sensing device 120. The first wireless sensing device 110 and the second wireless sensing device 120 (which are also referred to as wireless communication devices) communicate with each other to realize wireless sensing. In the embodiments of the present disclosure, the first wireless sensing device 110 is also referred to as a first node, and the second wireless sensing device 120 is also referred to as a second node. Besides, the first wireless sensing device 110 and the second wireless sensing device 120 are generically referred to as wireless sensing devices.

In some embodiments, there may be at least one first wireless sensing device and one or more second wireless sensing devices associated with the at least one first wireless sensing device. The number of the first wireless sensing device (that is, the first node) 110 and the second wireless sensing device (that is, the second node) 120 shown in the FIG. 1 is exemplary as well, as the embodiments of the present disclosure are not limited to any particular number.

The first node 110 may be a network device, a terminal device or other device with wireless signal transmission and reception capabilities, and the second node 120 may also be a network device, a terminal device or other device with wireless signal transmission and reception capabilities. In the example of FIG. 2, two first nodes (i.e., AP 210 and AP 220) and two second nodes (i.e., STA 230 and STA 240) communicate with each other for wireless sensing. It should be readily understood that the embodiments of the present disclosure are not limited to such types of the first and second nodes.

Alternatively, or additionally, the wireless sensing system 100 may include other device(s).

In some embodiments, the first wireless sensing device 110 is used as a sensing transmitter or a sensing receiver, and the second wireless sensing device 120 is used as a sensing receiver or a sensing transmitter. Whether the first wireless sensing device 110 or the second wireless sensing device 120 is a sensing transmitter or a sensing receiver may be determined according to practical needs.

In some embodiments, referring to FIG. 3, the wireless sensing device (e.g., the first wireless sensing device 110 and/or the second wireless sensing device 120) includes at least one processor 310 and a transceiver 320 coupled to the at least one processor 310, the at least one processor 310 is used to process signals, and the transceiver 320 is used to receive and send signals. In some examples, the transceiver 320 includes a set of antennas 325. In some other examples, the first wireless sensing device 110 and/or the second wireless sensing device 120 includes a plurality of antennas coupled to the transceiver 320.

For example, the processor 310 includes one or more central processing units (CPUs). The CPU is a single-core CPU (single-CPU) or a multi-core CPU (multi-CPU). The transceiver 320 includes a set of antennas (first antennas). The transceiver 320 may further include a radio-frequency circuit.

Alternatively, or additionally, the first wireless sensing device 110 and/or the second wireless sensing device 120 further includes a computer-readable memory 330, the memory 330 has stored thereon program instructions that, when executed by the processer(s) 310, cause the sensing transmitter or the sensing receiver to implement one or more steps of a method for wireless sensing as described below.

For example, the memory 330 includes, but is not limited to, random access memory (RAM), read only memory (ROM), erasable programmable read-only memory (EPROM), flash memory, or optical memory.

In some embodiments, the first wireless sensing device and the second wireless sensing device may be a chip or a system on chip (SoC).

The embodiments of the present disclosure may be applied to various communication network scenarios, such as Institute of Electrical and Electronics Engineers (IEEE) 802.11 standard (e.g., 802.11a/b/g, 802.11n, 802.11ac, 802.11ax, 802.11be, 802.11ad, 802.11ay, or 802.11bf), internet of things (IoT) network, Vehicle to X (V2X) network, WLAN or Wi-Fi. Of course, the embodiments of the present disclosure may be applied to other communication systems, such as LTE system, LTE frequency division duplex (FDD) system, LTE time division duplex (TDD) system, universal mobile telecommunication system (UMTS), worldwide interoperability for microwave access (WiMAX) communication system, 5G communication system, or 6G communication system. The embodiments of the present disclosure are described by taking Wi-Fi communication network as an example.

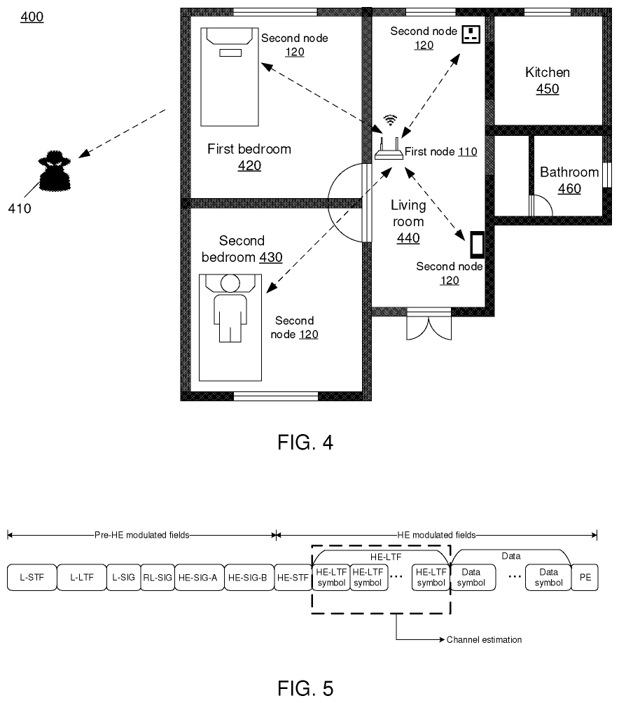

The embodiments of the present disclosure may be used in various sensing scenarios, such as human presence detection, posture recognition, fall detection, intrusion detection, elderly care, gesture recognition, respiratory and sleep monitoring, and indoor population statistics. Considering a sensing scenario in a home environment 400 shown in FIG. 4 as an example, as shown in FIG. 4, the home environment 400 includes one first node 110, multiple second nodes 120, the first bedroom 420, the second bedroom 430, the living room 440, the kitchen 450 and the bathroom 460. The first node 110 is located in the living room, and the first node 110 may be a router; and the multiple second nodes 120 are located in the first bedroom 420, second bedroom 430, and living room 440, and the second nodes 120 may be a mobile phone, smart socket, smart lamp and air purifier. The first node 110 and the second nodes 120 communicate with each other to realize the monitoring of the home environment 400. In the case where the first node 110 is a sensing initiator and the second nodes 120 are sensing responders, the first node 110 can communicate with the second node 120 in the first bedroom 420 to monitor the sleep status of the user, the first node 110 can communicate with the second nodes 120 in the living room 440 to monitor the status of the living room 440, and the first node 110 can communicate with the second node 120 in the second bedroom 430 to monitor the status of the second bedroom 430. In the case where the first node 110 is a sensing responder and the second nodes 120 are sensing initiators, the second nodes 120 in different locations can each communicate with the first node 110 to monitor the status of the living room 440.

For example, the sensing initiator may send PPDUs for sensing measurement to the sensing responder, and the responder may obtain a channel estimation result (e.g., a sequence of CSI) based on the PPDUs. Then, the sensing responder may send the channel estimation result to the sensing initiator, and the sensing initiator performs the sensing measurement based on the channel estimation result. In this case, the sensing initiator is a sensing transmitter and the sensing responder is a sensing receiver.

Referring to FIG. 4, if an unauthorized device (i.e., an eavesdropping device or eavesdropper) 410 exists in the proximity of a home environment 400, the unauthorized device 410 may receive sensing PPDUs that are continuously transmitted in the environment 400 and perform a sequence of CSI estimations to implement a wireless sensing application, resulting in violating the privacy of legitimate wireless sensing users. For example, the eavesdropper 410 may implement a wireless sensing application to detect whether or not the home is currently empty. As a result, the privacy related to the home environment 400 may be leaked.

In light of this, in some embodiments of the present disclosure, a method for wireless sensing is provided to prevent an eavesdropper from violating the privacy of legitimate wireless sensing users. The method is used for privacy protection in a wireless sensing environment, and its main purpose is to transmit fake sensing data unit(s) to prevent the eavesdropper from implementing a sensing application that violates the privacy of legitimate wireless sensing users. For example, the eavesdropper may obtain fake CSI based on the fake sensing data units, thus preventing the privacy of legitimate wireless sensing users being violated. The details of how the fake CSI is generated will be further described below.

Referring to FIG. 5, a PPDU in Wi-Fi 6 PPDU format as an example of the wireless sensing data unit is described. As shown in the FIG. 5, the PPDU includes pre-high-efficiency (HE) modulated fields and HE modulated fields. The pre-HE modulated fields include non-high-throughput (HT) short training field (L-STF), non-HT long training field (L-LTF), non-HT signal field (L-SIG), repeated non-HT signal field (RL-SIG), HE signal A field (HE-SIG-A), and HE signal B field (HE-SIG-B). The HE modulated fields include HE short training field (HE-STF), HE long training field (HE-LTF), data field, and packet extension field (PE). Among the fields of the PPDU, the HE-LTF contains channel estimation sequence (for example, a sequence of zeros and ones that is known to the sensing transmitter and sensing receiver) used for channel estimation (e.g., CSI estimation), and the data field is used for carrying a physical layer service data unit (PSDU). It should be noted that the type of the wireless sensing data unit in the embodiments of the present disclosure is not limited thereto. In addition to the HE PPDU (WiFi 6), a wireless sensing data unit can be a high-throughput (HT) PPDU, i.e., HT PPDU (WiFi 4), a very high-throughput (VHT) PPDU, i.e., VHT PPDU (WiFi 5), an extremely high-throughput (EHT) PPDU, i.e., EHT PPDU (WiFi 7), or any other PPDU format defined in a future WiFi standard.

In the embodiments of the present disclosure, the ‘fake’ wireless sensing data unit is referred to as a first wireless sensing data unit, and the ‘actual’ wireless sensing data unit is referred to as a second wireless sensing data unit. The ‘fake’ wireless sensing data unit may be generated in the following manners. The method of generating the ‘fake’ wireless sensing data unit in embodiments of the present disclosure is not limited thereto.

In some embodiments, in a first manner, generating the ‘fake’ wireless sensing data unit by corrupting the field for CSI estimation in the wireless sensing data unit. In other words, a first value of the field for CSI estimation in the ‘fake’ wireless sensing data unit (that is, the first wireless sensing data unit) is different from a second value of the field for the CSI estimation in the ‘actual’ wireless sensing data unit (that is, the second wireless sensing data unit). For example, the wireless sensing data unit is the PPDU as shown in the FIG. 5, and the field for the CSI estimation in the wireless sensing data unit is the HE-LTF. The value of the HE-LTF in the ‘fake’ PPDU is different from the value of the HE-LTF in the ‘actual’ PPDU.

In this way, the eavesdropper receives both the actual and ‘fake’ sensing data units. Furthermore, the eavesdropper obtains the ‘fake’ CSI based on the ‘fake’ sensing data unit (for example, based on the first value in the ‘fake’ wireless sensing data unit). As a result, the method is used to corrupt the sequence of channel estimations performed by the eavesdropper, thus significantly reducing its ability to implement a useful sensing application.

In the following, methods for determining the first value are described.

In some embodiments, the first value is determined based on a first parameter, and the first parameter is used to influence a value of a baseband signal for the CSI estimation, while the second value is determined based on a predefined second parameter that is used to obtain the baseband signal (that is, the actual baseband signal that has not been corrupted), and the second parameter is different from the first parameter.

For example, the value of the baseband signal for the CSI estimation may result in the estimation of a channel vector (which is described below). In this case, the illegitimate sensing receiver (for example, the eavesdropper) may obtain a ‘fake’ value of the baseband signal based on the first parameter, which may corrupt the CSI estimation (e.g., result in the estimation of a ‘fake’ channel vector). Therefore, it may be possible to prevent the illegitimate sensing receiver (for example, the eavesdropper) from estimating the actual channel vector and in turn protect the privacy of legitimate wireless sensing users.

In some embodiments, the first parameter includes a first spatial mapping matrix and/or a first channel estimation sequence while the second parameter includes a second spatial mapping matrix that is different from the first spatial mapping matrix and/or a second channel estimation sequence that is different from the first channel estimation sequence.

In the case where the first parameter includes the first spatial mapping matrix and the second parameter includes the second spatial mapping matrix, the second spatial mapping matrix is a predefined spatial mapping matrix, and the first spatial mapping matrix is a random (unitary) spatial mapping matrix that is different from the predefined spatial mapping matrix. Therefore, the first value determined based on the first spatial mapping matrix is randomized compared with the second value determined based on the second spatial mapping matrix. In this way, it may be possible to prevent an illegitimate sensing receiver from estimating the actual channel information.

In the following, considering the PPDU as shown in the FIG. 5 as an example, examples of the first spatial mapping matrix and the second spatial mapping matrix are described.

In some examples, CSI is the main input to the majority of Wi-Fi sensing applications, and each CSI sample is obtained from a received PPDU. The CSI sample includes Discrete Fourier Transform (DFT) samples of the baseband channel impulse response between the transmit antenna and the receive antenna, as estimated from the high-efficiency long training field (HE-LTF) fields of a received PPDU. A sequence of CSI samples is the input to the Wi-Fi sensing applications. The embodiments of the present disclosure are described by taking Wi-Fi 6 PPDU format as an example.

For example, an HE-LTF complex envelop of the received signal by focusing on a certain sub-carrier, denoted by a k-th sub-carrier is expressed by the following formula (i):

$${y}_{m} ( t ) = {\sum }_{l = 1}^{{N}_{Tx}} {h}_{ml}^{( k )} {x}_{l} ( t ) + {n}_{m} ( t ) \qquad ( i )$$

Here, yₘ(t) is a baseband signal received by an m^{th} antenna;

$${h}_{ml}^{( k )}$$

is a complex channel coefficient; xₗ(t) is a baseband signal transmitted by an l^{th} antenna; and nₘ(t) is additive white Gaussian noise (AWGN) at the m^{th} received antenna; and m=1, . . . , N_{Rx}, N_{Rx} is the number of receiving antennas; N_{Tx} is the number of transmitting antennas.

If a random spatial mapping matrix is introduced, based on the above formula (i), and by using the HE-LTF baseband signal as defined in the IEEE 802.11ax standard, the following formulas (ii) and (iii) in a matrix form are obtained:

$$\begin{matrix}( {y}_{m} ( 0 ) , … , {y}_{m} ( ( {N}_{HE - LTF} - 1 ) {T}_{HE - LTF} ) ) = \\ ( {h}_{m 1}^{( k )} , … , {h}_{{mN}_{TX}}^{( k )} ) ( \begin{matrix}{q}_{11}^{( k )} & … & {q}_{1 {N}_{STS}}^{( k )} \\ ⋮ & ⋱ & ⋮ \\ {q}_{{N}_{TX} 1}^{( k )} & … & {q}_{{N}_{TX} {N}_{STS}}^{( k )}\end{matrix} ) ( \begin{matrix}{e}^{- j 2 π k Δ {fT}_{cs} ( 1 )} & … & 0 \\ ⋮ & ⋱ & ⋮ \\ 0 & … & {e}^{- j 2 π k Δ {fT}_{cs} ( {N}_{STS} )}\end{matrix} ) \\ ( \begin{matrix}{p}_{11} & … & {p}_{1 {N}_{HE - LTF}} \\ ⋮ & ⋱ & ⋮ \\ {p}_{{N}_{STS} 1} & … & {p}_{{N}_{STS} {N}_{HE - LTF}}\end{matrix} ) {HELTF}_{k} + {\underline{n}}_{m}\end{matrix} \qquad ( ii )$$

$$\begin{matrix}( {\tilde{h}}_{m 1}^{( k )} , … , {\tilde{h}}_{{mN}_{STS}}^{( k )} ) = \frac{1}{{N}_{HE - LTF}} ( {y}_{m} ( 0 ) , … , {y}_{m} ( ( {N}_{HE - LTF} - 1 ) {T}_{HE - LTF} ) ) {( \begin{matrix}{p}_{11} & … & {p}_{1 {N}_{HE - LTF}} \\ ⋮ & ⋱ & ⋮ \\ {p}_{{N}_{STS} 1} & … & {p}_{{N}_{STS} {N}_{HE - LTF}}\end{matrix} )}^{*} {HELF}_{k}^{*} + \\ \frac{1}{{N}_{HE - LTF}} {\underline{n}}_{m} {( \begin{matrix}{p}_{11} & … & {p}_{1 {N}_{HE - LTF}} \\ ⋮ & ⋱ & ⋮ \\ {p}_{{N}_{STS} 1} & … & {p}_{{N}_{STS} {N}_{HE - LTF}}\end{matrix} )}^{*} {HELF}_{k}^{*}\end{matrix} \qquad ( iii )$$

Here, j is the imaginary unit, i.e., j=\sqrt{−1}; N_{STS} is the number of transmit space-time streams (STSs), Δf is the sub-carrier frequency spacing for the HE modulated fields; T_{cs}(i) is the cyclic shift value for the HE modulated fields for the i^{th} STS, where

$$i = 1 , … , {N}_{STS} ; ( \begin{matrix}{q}_{11}^{( k )} & … & {q}_{1 {N}_{STS}}^{( k )} \\ ⋮ & ⋱ & ⋮ \\ {q}_{{N}_{TX} 1}^{( k )} & … & {q}_{{N}_{TX} {N}_{STS}}^{( k )}\end{matrix} )$$

is a random spatial mapping matrix;

$$( \begin{matrix}{e}^{- j 2 π k Δ {fT}_{cs} ( 1 )} & … & 0 \\ ⋮ & ⋱ & ⋮ \\ 0 & … & {e}^{- j 2 π k Δ {fT}_{cs} ( {N}_{STS} )}\end{matrix} )$$

is a diagonal matrix to account for the cyclic shifts; N_{HE-LTF} is the length of the channel estimation sequence, i.e., the number of transmitted HE-LFT symbols,

$$( \begin{matrix}{p}_{11} & … & {p}_{1 {N}_{HE - LTF}} \\ ⋮ & ⋱ & ⋮ \\ {p}_{{N}_{STS} 1} & … & {p}_{{N}_{STS} {N}_{HE - LTF}}\end{matrix} )$$

is a unitary matrix (multiplied by a constant) that determines a channel estimation sequence that consists of N_{HE-LTF} symbols for each transmit STS of the k^{th} sub-carrier; HELTFₖ is a defined integer that depends on the sub-carrier index, k, where HELTFₖ∈{−1, 0, 1}; the i^{th} row of the matrix

$$( \begin{matrix}{p}_{11} & … & {p}_{1 {N}_{HE - LTF}} \\ ⋮ & ⋱ & ⋮ \\ {p}_{{N}_{STS} 1} & … & {p}_{{N}_{STS} {N}_{HE - LTF}}\end{matrix} ) {HELTF}_{k}$$

is a channel estimation sequence for the i^{th} STS of the k^{th} sub-carrier, where i=1, . . . , N_{STS}; T_{HE-LTF} is the duration of an HE-LTF symbol; and nₘ=(nₘ(0), . . . , nₘ((N_{HE-LTF}−1)T_{HE-LTF})) is a noise vector.

The matrix

$$( \begin{matrix}{p}_{11} & … & {p}_{1 {N}_{HE - LTF}} \\ ⋮ & ⋱ & ⋮ \\ {p}_{{N}_{STS} 1} & … & {p}_{{N}_{STS} {N}_{HE - LTF}}\end{matrix} ) {HELTF}_{k}$$

is known to the sensing transmitter and the sensing receiver, and is used to generate the HE-LTF field of the PPDU for CSI estimation. Compared with the actual PPDU (the second wireless sensing data unit), the fake PPDU (the first wireless sensing data unit) has an additional mapping matrix, which is a random spatial mapping matrix (i.e., the first spatial mapping matrix), so that the first wireless sensing data unit is randomized, and the sensing transmitter will transmit the actual PPDU with the HE-LTF field that can be used to obtain the actual channel vector as in the standard rather the fake PPDU with the HE-LTF field that can corrupt the actual channel vector. Therefore, it may be possible to prevent the illegitimate sensing receiver (i.e., the eavesdropper) from estimating the actual channel vector, and in turn protect the privacy of legitimate wireless sensing users.

Then,

$$( {y}_{m} ( 0 ) , … , {y}_{m} ( ( {N}_{HE - LTF} - 1 ) {T}_{HE - LTF} ) ) = ( {\tilde{h}}_{m 1}^{( k )} , … , {\tilde{h}}_{{mN}_{STS}}^{( k )} ) ( \begin{matrix}{p}_{11} & … & {p}_{1 {N}_{HE - LTF}} \\ ⋮ & ⋱ & ⋮ \\ {p}_{{N}_{STS} 1} & … & {p}_{{N}_{STS} {N}_{HE - LTF}}\end{matrix} ) {HELTF}_{k} + {\underline{n}}_{m} .$$

Here,

$$( {\tilde{h}}_{m 1}^{( k )} , … , {\tilde{h}}_{{mN}_{STS}}^{( k )} )$$

is the channel vector estimated by the eavesdropper, which includes the effect of the randomized Qₖ matrix.

In the case where the first value of the baseband signal for the CSI estimation is determined based on the first spatial mapping matrix and the second value is determined based on the second spatial mapping matrix, the first value is determined based on

$$( {h}_{m 1}^{( k )} , … , {h}_{{mN}_{TX}}^{( k )} ) ( \begin{matrix}{q}_{11}^{( k )} & … & {q}_{1 {N}_{STS}}^{( k )} \\ ⋮ & ⋱ & ⋮ \\ {q}_{{N}_{TX} 1}^{( k )} & … & {q}_{{N}_{TX} {N}_{STS}}^{( k )}\end{matrix} ) ( \begin{matrix}{e}^{- j 2 π k Δ {fT}_{cs} ( 1 )} & … & 0 \\ ⋮ & ⋱ & ⋮ \\ 0 & … & {e}^{- j 2 π k Δ {fT}_{cs} ( {N}_{STS} )}\end{matrix} ) ,$$

and the second value is determined based on

$$( {h}_{m 1}^{( k )} , … , {h}_{{mN}_{TX}}^{( k )} ) ( \begin{matrix}{e}^{- j 2 π k Δ {fT}_{cs} ( 1 )} & … & 0 \\ ⋮ & ⋱ & ⋮ \\ 0 & … & {e}^{- j 2 π k Δ {fT}_{cs} ( {N}_{STS} )}\end{matrix} ) .$$

In the case where the first parameter includes the first channel estimation sequence and the second parameter includes the second channel estimation sequence, the second channel estimation sequence is a predefined channel estimation sequence, and the first channel estimation sequence is a random channel estimation sequence that is different from the predefined channel estimation sequence. Based on the above description, the rows of the matrix

$$( \begin{matrix}{p}_{11} & … & {p}_{1 {N}_{HE - LTF}} \\ ⋮ & ⋱ & ⋮ \\ {p}_{{N}_{STS} 1} & … & {p}_{{N}_{STS} {N}_{HE - LTF}}\end{matrix} ) {HELTF}_{k}$$

are the channel estimation sequences for all STSs. The second channel estimation sequence matrix is a standardized matrix for each sub-carrier, for example,

$$[ \begin{matrix}1 & - 1 & 1 & 1 \\ 1 & 1 & - 1 & 1 \\ 1 & 1 & 1 & - 1 \\ - 1 & 1 & 1 & 1\end{matrix} ] ,$$

which is known to the sensing transmitter and the sensing receiver. In this case, the first value of the baseband signal for the CSI estimation determined based on the first channel estimation sequence is randomized compared with the second value determined based on the second channel estimation sequence, and the first value (i.e., the fake value) is different from the second value (i.e., the actual value). In this way, it may be possible to prevent an illegitimate sensing receiver from estimating the actual channel information.

In addition, the random spatial mapping matrix, the channel estimation sequence, both the random spatial mapping matrix and the channel estimation sequence, or any other method for channel faking can be used to generate the first wireless sensing data unit (i.e., the fake wireless sensing data unit), and the embodiments of the present disclosure are not limited thereto.

In some embodiments, in a second manner, the ‘actual’ wireless sensing data unit and the ‘fake’ wireless sensing data unit are transmitted via a set of antennas with different antenna radiation patterns.

For ‘actual’ wireless sensing data unit(s), a wireless sensing device (e.g., the first wireless sensing device or the second wireless sensing device) may send the ‘actual’ wireless sensing data unit(s) via a set of antennas with a predefined antenna radiation pattern.

For ‘fake’ wireless sensing data unit(s), a wireless sensing device (e.g., the first wireless sensing device or the second wireless sensing device) may send the ‘fake’ wireless sensing data unit(s) via a set of antennas with a random antenna radiation pattern. The random antenna radiation pattern may be randomly selected from an available set of radiation patterns. For example, the set of antennas includes four antennas, each antenna adopts a single antenna radiation pattern, and the antenna radiation pattern for any of the four antennas may be randomly selected.

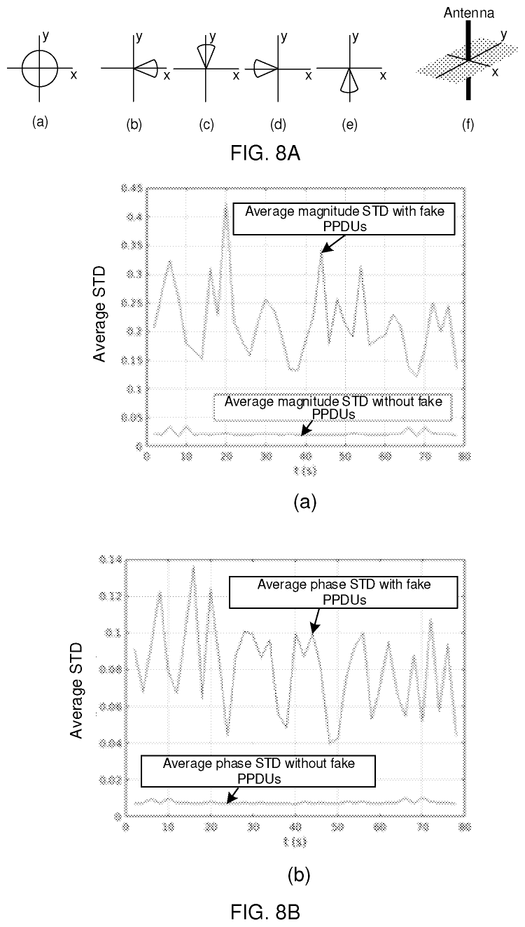

The types of predefined and random antenna radiation patterns are not limited in the embodiments of the present disclosure, which may be selected according to practical needs. For example, referring to (a) of FIG. 8A, the predefined antenna radiation pattern is an omni-directional radiation pattern, which may be used for all antennas to transmit the ‘actual’ wireless sensing data units; referring to (b) to (e) of FIG. 8A, there are radiation patterns for each of four antennas, each antenna has a beam directed towards a positive direction of the x axis, a positive direction of the y axis, a negative direction of the x axis, or a negative direction of the y axis, and the boresight direction for the antenna may be changed with a step of 90° in a specified plane defined by the x and y axes. One or more of the four directional antenna radiation patterns of the four antennas may be used to transmit the ‘fake’ wireless sensing data units, and the antenna radiation pattern for each antenna is randomly selected from a set of possible radiation patterns, which will not be limited herein. For example, all ‘fake’ wireless sensing data units may use the same antenna radiation pattern or different antenna radiation patterns for transmission.

In the embodiments of the present disclosure, the predefined antenna radiation pattern is referred to as a first predefined antenna radiation pattern, and the random antenna radiation pattern is referred to as a second antenna radiation pattern.

In some embodiments, the ‘fake’ wireless sensing data unit and the ‘actual’ wireless sensing data unit are transmitted by different wireless sensing devices. For example, the ‘fake’ wireless sensing data unit is transmitted by the second wireless sensing device, and the ‘actual’ wireless sensing data unit is transmitted by the first wireless sensing device. In this case, the first wireless sensing data unit is transmitted by the second wireless sensing device via a set of second antennas with the second antenna radiation pattern; and the second wireless sensing data unit is transmitted by the first wireless sensing device via a set of first antennas with the predefined first antenna radiation pattern.

In some other embodiments, the ‘fake’ wireless sensing data unit and the ‘actual’ wireless sensing data unit are transmitted by the same wireless sensing device. For example, the first wireless sensing data unit is transmitted by the first wireless sensing device via the set of first antennas with the second antenna radiation pattern; and the second wireless sensing data unit is transmitted by the first wireless sensing device via the set of first antennas with the predefined first antenna radiation pattern. In this case, the predefined first antenna radiation pattern is different from the second antenna radiation pattern.

Since the eavesdropper cannot identify the ‘actual’ and ‘fake’ wireless sensing data units that are sent via different antenna radiation patterns, the eavesdropper obtains a sequence of ‘fake’ and ‘actual’ channel estimations, so that the eavesdropper cannot implement a wireless sensing application (e.g., a Wi-Fi sensing application) to detect actual information of the wireless sensing environment (for example, whether a certain room in a home environment 400 shown in FIG. 4 is currently empty), which may decrease the ability of the eavesdropping device to implement a useful wireless sensing application, and in turn protect the privacy of legitimate wireless sensing users.

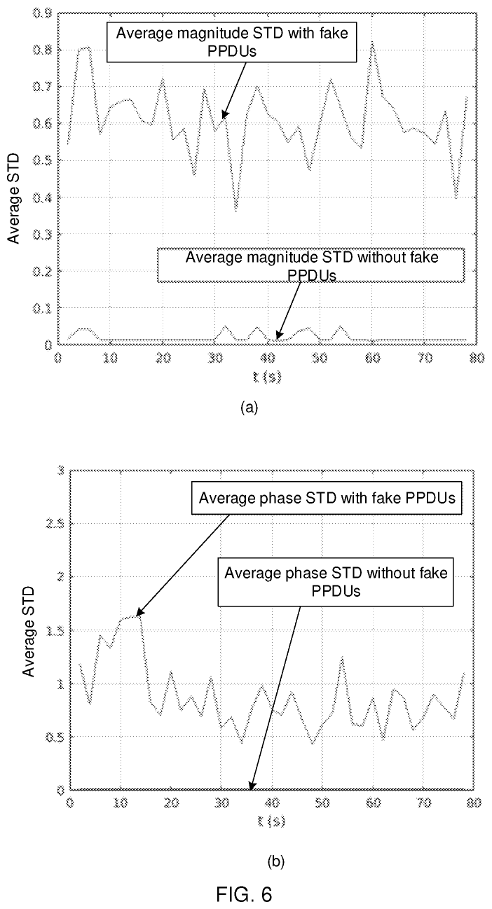

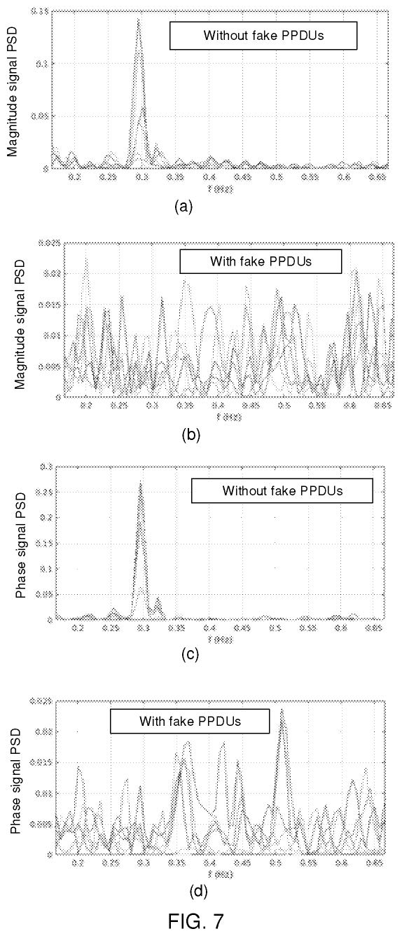

For example, if an experimental test is conducted in a home environment where a sensing receiver is in the living room and a sensing transmitter is in the first bedroom, when a random spatial mapping matrix is used for generating the ‘fake’ PPDUs, referring to (a) and (b) of FIG. 6, the standard deviation (STD) of magnitude and phase signals averaged over multiple sub-carrier indices with fake PPDUs is respectively higher than the STD of magnitude and phase signals averaged over multiple sub-carrier indices without fake PPDUs; and referring to (a) to (d) of FIG. 7, through respiration rate monitoring for a sleeping person via power spectral density (PSD) calculation (where actual respiration rate is 18 breath-per-minute (bpm), which is equal to 0.3 Hz), the PSD of magnitude and phase signals with fake PPDUs is disorder relative to the PSD of magnitude and phase signals without fake PPDUs. For another example, referring to (a) and (b) in FIG. 8B, when a random antenna radiation pattern manner is used for generating the ‘fake’ PPDUs, the STD of magnitude and phase signals averaged over multiple sub-carrier indices with fake PPDUs is higher than the STD of magnitude and phase signals averaged over multiple sub-carrier indices without fake PPDUs. Therefore, the ‘fake’ wireless sensing data unit may result in a CSI estimation that is significantly different from the CSI estimation from the ‘actual’ wireless sensing data unit.

The ‘fake’ wireless sensing data unit may be generated by using at least one of random spatial mapping matrix, random channel estimation sequence, or random antenna radiation pattern. The embodiments of the present disclosure are not limited thereto.

The embodiments of the present disclosure are not limited to any number of sensing initiators, any number of sensing responders, any types of the sensing initiator and sensing responder. For example, the sensing initiator is a sensing transmitter, and the sensing responder is a sensing receiver; alternatively, the sensing initiator is a sensing receiver, and the sensing responder is a sensing transmitter. For example, the sensing initiator is a terminal device, and the sensing responder is a network device; or, the sensing initiator is a network device, and the sensing responder is a terminal device; or, the sensing initiator and the sensing responder are both network devices; or, the sensing initiator and the sensing responder are both terminal devices.

The embodiments/implementations of the present disclosure are described below by taking an example in which two wireless sensing devices (e.g., the first wireless sensing device 110 and the second wireless sensing device 120 as shown in FIG. 1) are legitimate (authorized) devices for wireless sensing. In some embodiments, the first wireless sensing device 110 is a sensing transmitter, and the second wireless sensing device 120 is a sensing receiver. In addition, there is an illegitimate (unauthorized) wireless sensing device, which is regarded as an eavesdropper to violate the wireless sensing of the two wireless sensing devices.

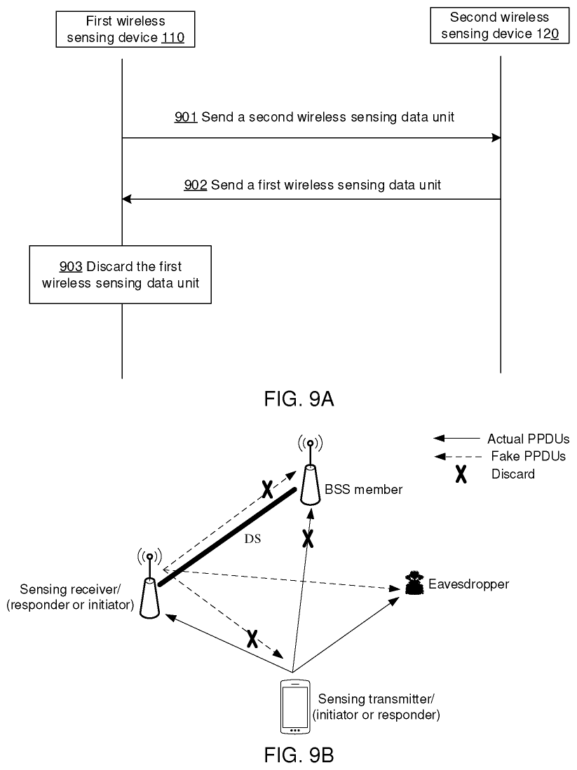

In a first scenario, in some embodiments, referring to FIGS. 9A and 9B, the first wireless sensing device 110 is a sensing initiator, and the second wireless sensing device 120 is a sensing responder; alternatively, the first wireless sensing device 110 is a sensing responder, and the second wireless sensing device 120 is a sensing initiator. It should be noted that the sensing initiator can initiate a sensing procedure, and a wireless sensing application is implemented on the sensing initiator; and the sensing responder participates in the sensing procedure initiated by the sensing initiator. Also, in some embodiments, referring to FIGS. 9A and 9B, the first wireless sensing device 110 is a sensing transmitter, and the second wireless sensing device 120 is a sensing receiver. The first scenario is described by taking an example in which the first wireless sensing device is a non-AP STA, and the second wireless sensing device is an AP. Besides, in the first scenario, the second wireless data unit is an ‘actual’ wireless sensing data unit and the first wireless data unit is a ‘fake’ wireless sensing data unit as described above.

Referring to FIG. 9A, the method for wireless sensing includes the following steps.

In step 901, the first wireless sensing device 110 sends a second wireless sensing data unit to the second wireless sensing device 120. Accordingly, the second wireless sensing device 120 receives the second wireless sensing data unit from the first wireless sensing device 110. If there exists an unauthorized device (for example, the eavesdropper) as described above, the eavesdropper may also receive the second wireless sensing data unit.

A value of a receiving address (RA) field in the second wireless sensing data unit is an address of the second wireless sensing device 120, and a value of a transmitting address (TA) field in the second wireless sensing data unit is an address of the first wireless sensing device 110.

For example, the second wireless sensing data unit is a PPDU carrying a medium access control (MAC) layer protocol data unit (MPDU), and the PPDU transmitted by the first wireless sensing device includes the MAC address of the first wireless sensing device 110 and the MAC address of the second wireless sensing device 120 which are respectively in the TA and RA fields of the header of the MPDU carried by the PPDU that is transmitted by the first wireless sensing device 110. That is, the values of the TA and RA fields of the header of the MPDU carried by the PPDU that is transmitted by the first wireless sensing device 110 are respectively the MAC address of the first wireless sensing device 110 and the MAC address of the second wireless sensing device 120.

In step 902, the second wireless sensing device sends a first wireless sensing data unit.

After receiving the second wireless sensing data unit as described in the step 901, the second wireless sensing device 120 generates the first wireless sensing data unit based on the second wireless sensing data unit. In some embodiments, a value of the RA field and a value of the TA field in the first wireless sensing data unit are the same as the value of the RA field and the value of the TA field in the second wireless sensing data unit, respectively. That is, the value of the RA field in the first wireless sensing data unit is the address of the second wireless sensing device, and the value of the TA field in the first wireless sensing data unit is the address of the first wireless sensing device.

For example, the first wireless sensing data unit is a PPDU carrying an MPDU, and the second wireless sensing device transmits the first wireless sensing data unit that includes the MAC address of the first wireless sensing device and its own MAC address in the TA field and RA field of the header of the MPDU carried by the first wireless sensing data unit, respectively.

Corresponding to the step 902, other devices, for example, the first wireless sensing device and/or the eavesdropper receives the first wireless sensing data unit. The devices that have received the first wireless sensing data unit may process the first wireless sensing data in different ways.

In step 903, the first wireless sensing device discards the first wireless sensing data unit based on the value of the RA field in the first wireless sensing data unit.

In this case, since the value of the RA field in the first wireless sensing data unit is not matched with the address of the first wireless sensing device, the first wireless sensing device will discard the first wireless sensing data unit, which will not affect the legitimate wireless sensing procedure. However, since the first wireless sensing data unit and the second wireless sensing data unit have the same values of the TA and RA fields, the eavesdropper may mistakenly understand that the two wireless sensing data units are transmitted by the same sensing transmitter, and the eavesdropper will process the wireless sensing data units (for example, estimate the channel based on the sequence of the first and second wireless sensing data units) to implement a wireless sensing application. In this way, the wireless sensing application on the eavesdropper may not be implemented to violate the privacy of legitimate wireless sensing users, which decreases the ability of the eavesdropper to implement a useful wireless sensing application, and in turn protect the privacy of legitimate wireless sensing users.

In some examples, there is a basic service set (BSS), BSS members include the second wireless sensing device and other wireless sensing devices (such as an AP), and all the BSS members may receive the first wireless sensing data unit. However, since the RA field of the carried MPDU header is set to the MAC address of the second wireless sensing device, which does not match the addresses of the BBS members, all the BSS members will discard the first wireless sensing data unit.

In order to implement a wireless sensing application, a sequence of channel estimation is required. If the sequence of channel estimation is all estimated by actual wireless sensing data units (e.g., actual PPDUs), all channel vectors in the sequence of channel estimation are correct, and the wireless sensing application will be implemented. If the sequence of channel estimation is estimated by actual and fake wireless sensing data units (e.g., actual and fake PPDUs), some of the channel vectors are correct, some of the channel vectors are corrupted, and the wireless sensing application cannot be implemented. In this way, the sensing initiator can implement a useful sensing application, and the eavesdropper cannot implement a useful sensing application, so that the ability of the eavesdropper to implement a useful wireless sensing application is decreased, which avoids that the unauthorized wireless sensing application violates the privacy of legitimate wireless sensing users.

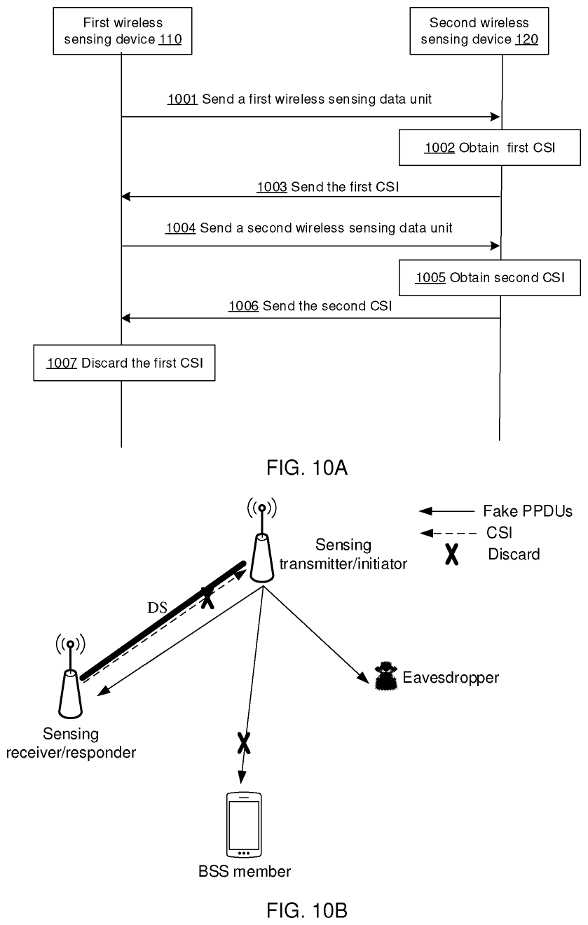

In a second scenario, in some embodiments, referring to FIGS. 10A and 10B, the first wireless sensing device 110 is a sensing initiator, and the second wireless sensing device 120 is a sensing responder. For example, the first wireless sensing device 110 and the second wireless sensing device 120 are both APs. Also, in some embodiments, referring to FIGS. 10A and 10B, the first wireless sensing device 110 is a sensing transmitter, and the second wireless sensing device 120 is a sensing receiver.

Referring to FIG. 10A, the method for wireless sensing includes the following steps.

In step 1001, the first wireless sensing device 110 sends a first wireless sensing data unit to the second wireless sensing device 120.

In step 1004, the first wireless sensing device 110 sends a second wireless sensing data unit to the second wireless sensing device 120.

Accordingly, the second wireless sensing device 120 receives the first wireless sensing data unit and the second wireless sensing data unit from the first wireless sensing device 110. The first wireless sensing data unit is different from the second wireless sensing data unit, and the first wireless sensing data unit is used to result in the CSI estimation that is different from the CSI estimation from the second wireless sensing data unit.

In step 1002, the second wireless sensing device 120 obtains first CSI based on the first wireless sensing data unit. That is, the sensing receiver obtains fake CSI.

In step 1005, the second wireless sensing device 120 obtains second CSI based on the second wireless sensing data unit. That is, the sensing receiver obtains actual CSI.

In step 1003, the second wireless sensing device 120 sends channel characteristic information to the first wireless sensing device 110. Accordingly, the first wireless sensing device 110 receives the channel characteristic information from the second wireless sensing device 120. The channel characteristic information includes the first CSI. For example, the channel characteristic information is transmitted through the wired link between the first wireless sensing device 110 and the second wireless sensing device 120.

For example, the CSI estimated from the fake sensing PPDU is transmitted by the sensing receiver to the sensing transmitter over the air or via a distribution system (DS) (e.g., the optical fiber connecting the sensing transmitter and the sensing receiver). The DS may include optical fibers connecting different sensing transmitters and sensing receivers.

In step 1006, the second wireless sensing device 120 sends channel characteristic information to the first wireless sensing device 110. Accordingly, the first wireless sensing device 110 receives the channel characteristic information from the second wireless sensing device 120. The channel characteristic information includes the second CSI.

In step 1007, the first wireless sensing device 110 discards the first CSI according to a corresponding relation between the first wireless sensing data unit and the first CSI.

The sensing receiver (i.e., the sensing responder) transmits the fake CSI to the sensing transmitter (i.e., the sensing initiator), and the CSI feedback will be discarded by the sensing transmitter (i.e., the sensing initiator) according to a corresponding relation between the fake wireless sensing data unit and the fake CSI. In this way, the sensing initiator will implement a wireless sensing application without the fake CSI, so that the fake CSI will not affect the wireless sensing procedure of the sensing initiator. Therefore, the first wireless sensing device 110 can implement a wireless sensing application based on a sequence of actual wireless sensing data units.

The eavesdropper cannot discard the fake CSI as the eavesdropper includes no such a corresponding relation between the fake wireless sensing data unit and the fake CSI as mentioned above. In this way, the eavesdropping device obtains a sequence of actual and fake channel estimations, so that the eavesdropping device cannot implement a wireless sensing application (e.g., a Wi-Fi sensing application) to detect actual information of the wireless sensing environment (for example, whether a certain room is currently empty), which may decrease the ability of the eavesdropping device to implement a useful wireless sensing application, and in turn protect the privacy of legitimate wireless sensing users.

In some examples, the channel characteristic information further includes the second CSI. In this way, the second wireless sensing device 120 (i.e., the sensing responder) transmits the actual CSI to the first wireless sensing device 110 (i.e., the sensing initiator), and the first wireless sensing device 110 (i.e., the sensing initiator) will implement the wireless sensing application based on the actual CSI, thus realizing wireless sensing.

In the case where the sensing receiver is the sensing initiator, since the sensing receiver estimates CSI and the sensing initiator implements the sensing application, the sensing receiver does not need to send the estimated CSI.

Therefore, due to the authorized wireless sensing communication relationship between the legitimate sensing transmitter and sensing receiver, the legitimate sensing receiver can identify the actual wireless sensing data unit and discard the fake wireless sensing data unit. However, the illegitimate sensing receiver, i.e., the eavesdropper, does not have the authorized wireless sensing communication relationship with the sensing transmitter, so it cannot identify the actual and fake wireless sensing data units. In this way, the eavesdropping device obtains a sequence of fake and actual channel estimations, so that the eavesdropping device cannot implement a wireless sensing application (e.g., a Wi-Fi sensing application) to detect actual information of the wireless sensing environment (for example, whether a certain room shown in FIG. 4 is currently empty), which may decrease the ability of the eavesdropping device to implement a useful wireless sensing application, and in turn protect the privacy of legitimate wireless sensing users.

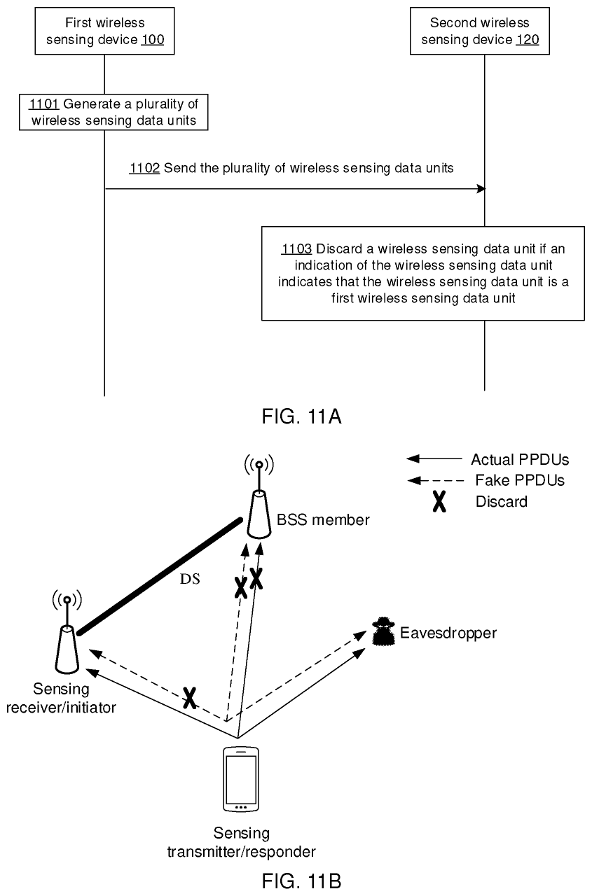

In a third scenario, in some embodiments, referring to FIGS. 11A and 11B, the first wireless sensing device 110 is a sensing responder, and the second wireless sensing device 120 is a sensing initiator. Also, in some embodiments, referring to FIGS. 11A and 11B, the first wireless sensing device 110 is a sensing transmitter, and the second wireless sensing device 120 is a sensing receiver. That is, the sensing transmitter is the sensing responder, and the sensing receiver is the sensing initiator.

Referring to FIG. 11A, the method for wireless sensing includes the following steps.

In step 1101, the first wireless sensing device 110 generates a plurality of wireless sensing data units.

In step 1102, the first wireless sensing device 110 sends the plurality of wireless sensing data units to the second wireless sensing device 120. Accordingly, the second wireless sensing device 120 receives the plurality of wireless sensing data units from the first wireless sensing device 110.

Each wireless sensing data unit of the plurality of wireless sensing data units includes an indication indicating whether the wireless sensing data unit is a first wireless sensing data unit or a second wireless sensing data unit.

In step 1103, the second wireless sensing device 120 discards the wireless sensing data unit if the indication of the wireless sensing data unit indicates that the wireless sensing data unit is the first wireless sensing data unit.

In a case where the wireless sensing data unit is a sensing PPDU, an MPDU carried by the sensing PPDU is encrypted (protected), and there is an indication in the data field in the MPDU carried by the PPDU. The indication of the sensing PPDU is configured to indicate whether the sensing PPDU is a ‘fake’ sensing PPDU or not. Since the first wireless sensing data unit is a ‘fake’ wireless sensing data unit (e.g., a ‘fake’ sensing PPDU), the second wireless sensing data unit is an ‘actual’ wireless sensing data unit (e.g., an ‘actual’ sensing PPDU), if the indication of the wireless sensing data unit indicates that the wireless sensing data unit is a first wireless sensing data unit, it means that the wireless sensing data unit is a ‘fake’ sensing PPDU, and the indication allows the second wireless sensing device 120 (i.e., the sensing receiver or the sensing initiator) to discard the wireless sensing data unit; and if the indication of the wireless sensing data unit indicates that the wireless sensing data unit is a second wireless sensing data unit, it means that the wireless sensing data unit is an ‘actual’ sensing PPDU, and the second wireless sensing device 120 may use the wireless sensing data unit to obtain CSI.

When the second wireless sensing device 120 receives a wireless sensing data unit, the wireless sensing device 120 may identify that the wireless sensing data unit is a first wireless sensing data unit or not based on the indication of the wireless sensing data unit. If it is identified that the wireless sensing data unit is a first wireless sensing data unit, which means that the wireless sensing data unit is a ‘fake’ wireless sensing data unit, then the wireless sensing data unit will be discarded. That is, the sensing receiver identifies a ‘fake’ sensing PPDU from the content of the carried protected MPDU, and then discards the ‘fake’ sensing PPDU.

Since the sensing transmitter is the sensing responder and the sensing receiver is the sensing initiator, the sensing responder (i.e., the sensing transmitter) sends a sequence of wireless sensing data units, and the sensing initiator (i.e., the sensing receiver) needs to know whether each wireless sensing data unit is actual or fake and discards the fake wireless sensing data unit. For example, the PPDU (e.g., the wireless sensing data unit) carries encrypted data, which is known to the AP (the sensing receiver) and the STA (the sensing transmitter) associated with the AP, and the indication is carried by the data, so that the data can indicate whether the PPDU is actual or fake; and the AP can decrypt the data to obtain the content of the data, and then discards the fake PPDU. Therefore, the second wireless sensing device 120 can implement a wireless sensing application based on a sequence of actual wireless sensing data units.

In some embodiments, the eavesdropper receives the plurality of wireless sensing data units from the first wireless sensing device 110.

The indication is in the data that is carried by the sensing PPDU (e.g., actual or fake PPDU) and the data is encrypted, and the encrypted data is not known to the eavesdropper. Therefore, the eavesdropper cannot differentiate the fake and actual PPDUs, the eavesdropper cannot discard fake wireless sensing data units, and the wireless sensing application on the eavesdropper may not be implemented based on the sequence of actual and fake wireless sensing data units. As a result, the ability of the eavesdropper to implement a useful wireless sensing application is decreased, and the privacy of legitimate wireless sensing users is protected.

In the above three scenarios, the ‘fake’ wireless sensing data unit can be transmitted by either the sensing receiver or the sensing transmitter. How the method using the ‘fake’ wireless sensing data unit to protect the privacy can be adopted based on the IEEE 802.11bf standard will be described below.

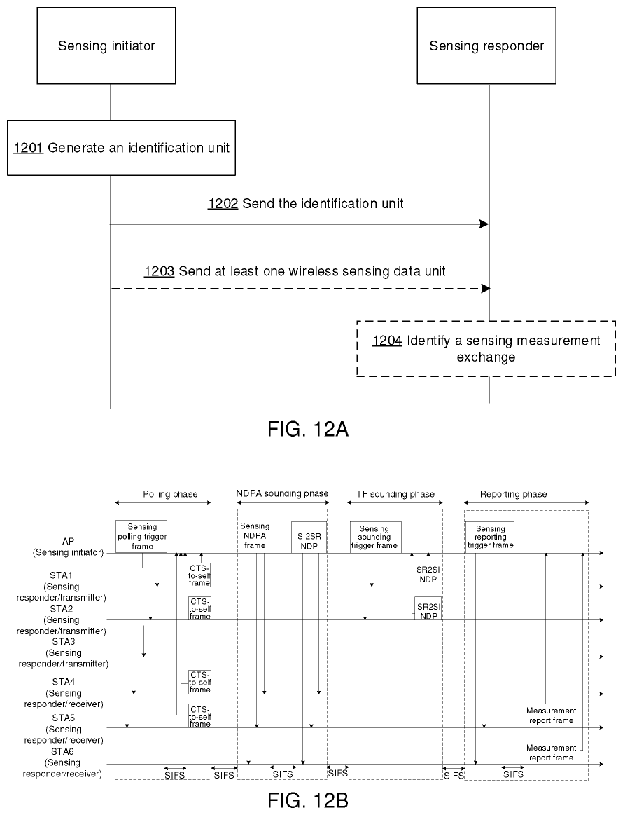

In some embodiments, in a fourth scenario, referring to FIG. 12A, the method includes the following steps. In some examples, the sensing initiator is the first wireless sensing device 110, and the sensing responder is the second wireless sensing device 120. In some other examples, the sensing initiator is the second wireless sensing device 120, and the sensing responder is the first wireless sensing device 110. It can be understood that the sensing initiator may be a sensing transmitter or a sensing receiver, and the sensing responder may be a sensing receiver or a sensing transmitter. Both the sensing transmitter and the sensing receiver can transmit ‘fake’ and ‘actual’ wireless sensing data units.

In step 1201, the sensing initiator generates an identification unit. The identification unit includes at least one first identification indicating a first sensing measurement exchange or at least one second identification indicating a second sensing measurement exchange.

In step 1202, the sensing initiator sends the identification unit to the sensing responder. Accordingly, the sensing responder receives the identification unit.

In some embodiments, each identification in the identification unit is included in an encrypted data field in the identification unit. For example, the identification unit may be a PPDU, and the identification (i.e., the first identification or the second identification) in the identification unit is included in an encrypted data field in the MPDU carried by the identification unit.

In a sensing measurement exchange, at least one wireless sensing data unit is transmitted between the first wireless sensing device and the second wireless sensing device.

In some embodiments, at least one wireless sensing data unit transmitted in the first sensing measurement exchange is a first wireless sensing data unit; and at least one wireless sensing data unit transmitted in the second sensing measurement exchange is a second wireless sensing data unit.

For example, one or more wireless sensing data units sent by the first wireless sensing device or the second wireless sensing device in the first sensing measurement exchange are all first wireless sensing data units; and one or more wireless sensing data units sent by the first wireless sensing device or the second wireless sensing device in the second sensing measurement exchange are all second wireless sensing data units.

In the embodiments of the present disclosure, the first identification is referred to as a ‘fake’ identification, and the first sensing measurement exchange is referred to as a ‘fake’ sensing measurement exchange; the second identification is referred to as an ‘actual’ identification, and the second sensing measurement exchange is referred to as an ‘actual’ sensing measurement exchange.

The eavesdropper cannot receive the identification unit, cannot identify a fake sensing measurement exchange, and cannot discard the first wireless sensing data units transmitted during this measurement exchange, so that the wireless sensing application on the eavesdropper may not be implemented based on a sequence of actual and fake wireless sensing data units. As a result, the ability of the eavesdropper to implement a useful wireless sensing application is decreased, and the privacy of legitimate wireless sensing users is protected.

This method can be applied to the IEEE 802.11bf standard. In the IEEE 802.11bf standard, there are two types of sensing measurement exchanges (also called sensing procedures). The first type is referred to as the trigger-based (TB) sensing measurement exchange, which is employed when the sensing initiator is an AP as shown in FIG. 12B. The second type is referred to as the non-TB sensing measurement exchange, which is employed when the sensing initiator is a non-AP STA as shown in FIG. 12C. In the IEEE 802.11bf standard, the sensing PPDU is an NDP.

In the TB sensing measurement exchange, the AP initiates a sensing procedure. FIG. 12B provides an example of the TB sensing measurement exchange. Referring to FIG. 12B, the AP is a sensing initiator, and the STAs 1 to 6 are sensing responders, where the STAs 1 to 3 are sensing transmitters and the STAs 4 to 6 are sensing receivers. In the polling phase, the AP may send a sensing polling trigger frame to the STAs 1 to 5, so that the STAs 1 to 5 may participate in the sensing procedure; and the STAs 1, 2, 4 and 5 may respectively send clear to send (CTS)-to-self frames to the AP. In the null data PPDU announcement (NDPA) sounding phase, the AP may send a sensing NDPA frame to the STAs 4 to 5, and then send sensing initiator to sensing responder (SI2SR) NDPs to the STAs 4 to 5, so that the STAs 4 to 5 may perform sensing measurement based on the SI2SR NDP to obtain CSI. In the trigger frame (TF) sounding phase, the AP may send a sensing sounding trigger frame to the STAs 1 and 2, and the STAs 1 and 2 may respectively send SR2SI NDPs to the AP, so that the AP may perform sensing measurement based on the SR2SI NDPs to obtain CSI. In the reporting phase, the AP may send a sensing reporting trigger frame to the STAs 5 and 6, and the STAs 5 and 6 may respectively send measurement report frames to the AP. There is a short interframe space (SIFS) between each frame. When the sensing initiator is a sensing receiver, the transmission of a sensing PPDU is preceded by the TF; and when the sensing initiator is a sensing transmitter, the transmission of a sensing PPDU is preceded by the NDPA frame. Each sensing measurement exchange is identified as an ‘actual’ or ‘fake’ sensing measurement exchange, such that in a ‘fake’ sensing measurement exchange, ‘channel faking’ is applied to all the transmitted PPDUs, including control frames. That is, all sensing PPDUs transmitted in the sensing measurement exchange need to be ‘fake’ PPDUs or ‘actual’ PPDUs. For example, the control frames include the sensing polling trigger frame, the CTS-to-self frame, the sensing NDPA frame, the sensing sounding trigger frame, the sensing reporting trigger frame, and the measurement report frame. In a first sensing measurement exchange, if the AP is a sensing transmitter, the AP discards the measurement report frame; and if the AP is a sensing receiver, the AP discards the ‘fake’ SR2SI NDP.

In the non-TB sensing measurement exchange, the sensing initiator is a non-AP STA, and the sensing responder is an AP. FIG. 12C provides an example of the non-TB sensing measurement exchange. Referring to FIG. 12C, the STA is a sensing initiator, and the AP is a sensing responder. In the measurement sounding phase, the STA sends a sensing NDPA frame to the AP; after an SIFS, the STA sends an SI2SR NDP to the AP, and the AP performs the CSI estimation based on the received NDP. Then, after an SIFS, the AP sends an SR2SI NDP to the STA, and the STA performs the CSI estimation based on the received NDP. In the reporting phase, the AP sends a sensing measurement report to the STA. The AP and the STA both can be a sensing transmitter. In a first sensing measurement exchange, if the STA is a sensing transmitter, the STA will discard the sensing measurement report frame; and if the STA is a sensing receiver, the STA will discard the ‘fake’ SR2SI NDP. Each sensing measurement exchange is identified as an ‘actual’ or ‘fake’ sensing measurement exchange, such that in a ‘fake’ sensing measurement exchange, ‘channel faking’ is applied to all the transmitted PPDUs, including the control frames (such as the sensing NDPA frame and the sensing measurement report frame).

In some embodiments, the first wireless sensing data unit or the second wireless sensing data unit may be a PPDU carrying data or a null data PPDU.

In some embodiments, the data carried by the first wireless sensing data unit or the second wireless sensing data unit may include a trigger frame, a clear to send (CTS)-to-self frame, a null data packet announcement (NDPA) frame, or a sensing measurement report frame (i.e., the measurement report frame). For example, the trigger frame includes the sensing polling trigger frame, the sensing sounding trigger frame, and the sensing reporting trigger frame.

In order to differentiate the ‘fake’ sensing measurement exchange in which all the PPDUs are fake and the actual sensing measurement exchange in which all the PPDUs are actual, the sensing initiator and the sensing responder should agree on the identifications of the ‘fake’ sensing measurement exchanges (fake sensing procedures). For example, the sensing initiator may periodically send a protected (encrypted) frame that includes the identifications of the ‘fake’ sensing measurement exchanges. Therefore, the fake wireless sensing data units (i.e., fake PPDUs) transmitted in a ‘fake’ sensing measurement exchange can be discarded, which is for the sake of privacy protection.

Since the frame including the identifications of fake sensing measurement exchanges is protected (encrypted), the eavesdropper does not know the content of the protected frame and cannot discard the ‘fake’ wireless sensing data units transmitted in a fake sensing measurement exchange. As a result, the eavesdropper cannot easily estimate a sequence of actual channel information from any one of the control frames transmitted in a sequence of sensing measurement exchanges.

For example, the agreement of the sensing initiator and the sensing responder may be achieved by the sensing initiator via periodic transmission of an encrypted (protected) frame that specifies the identifications of the ‘fake’ sensing measurement exchanges in an upcoming time duration. The identification of the sensing measurement exchange is included in the sounding dialog token number of the sounding dialog field of an NDPA frame. The identification of measurement session and the identification of measurement exchange (as defined in the IEEE 802.11bf standard) should be added to the sensing polling trigger frame, sensing responder to sensing initiator (SR2SI) sounding trigger frame (also known as a TF sounding phase), and/or sensing reporting trigger frame (possibly in the trigger dependent common info field).

In step 1203, the sensing initiator sends at least one wireless sensing data unit to the sensing responder. In some embodiments, at least one first wireless sensing data unit transmitted by the sensing initiator in the first sensing measurement exchange carries a first identification indicating a first sensing measurement exchange, where the first identification is previously transmitted by the sensing initiator to the sensing responder in a previous identification unit; and at least one second wireless sensing data unit transmitted by the sensing initiator in the second sensing measurement exchange carries a second identification indicating a second sensing measurement exchange, where the second identification is previously transmitted by the sensing initiator to the sensing responder in a previous identification unit.

In step 1204, the sensing responder identifies whether the sensing measurement exchange is the first sensing measurement exchange or the second sensing measurement exchange based on the identification carried by the wireless sensing data unit.

Based on the identification included in at least one wireless sensing data unit transmitted by a sensing initiator in a sensing measurement exchange, together with the identification units previously transmitted by the sensing initiator to a sensing responder, the sensing responder may identify whether the sensing measurement exchange is the first sensing measurement exchange or the second sensing measurement exchange.

If the sensing responder identifies that the sensing measurement exchange is the first sensing measurement exchange, any PPDU that the sensing responder sends during the sensing measurement exchange is a ‘fake’ PPDU. If the sensing responder identifies that the sensing measurement exchange is the second sensing measurement exchange, any PPDU that the sensing responder sends during the sensing measurement exchange is an actual PPDU.

It should be noted that the first wireless sensing data unit can be generated via the generation manners of the ‘fake’ wireless sensing data unit as described above, which will not be repeated here.

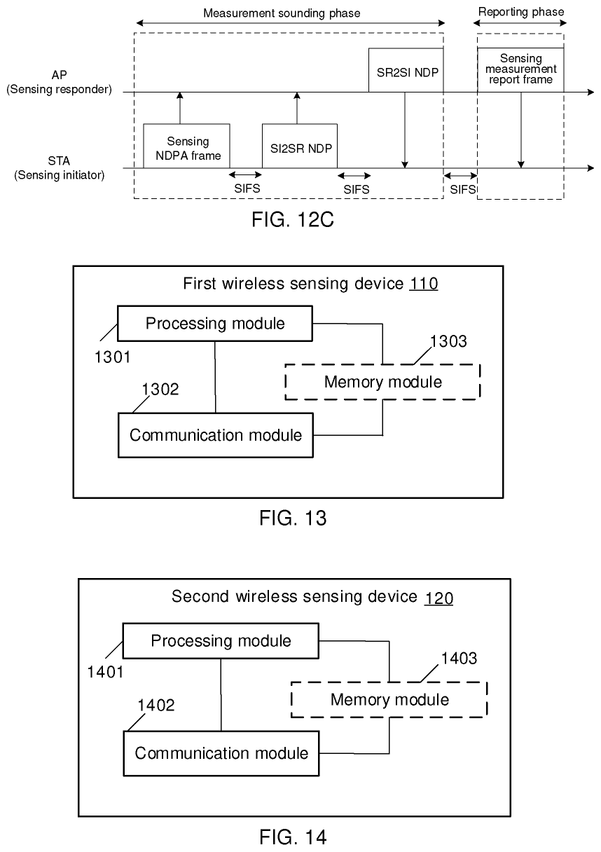

Some embodiments of the present disclosure provide a first wireless sensing device. The first wireless sensing device is used for performing some steps of the method for wireless sensing as described in the above embodiments/implementations. As shown in FIG. 13, the first wireless sensing device 110 includes a processing module 1301 and a communication module 1302. The processing module 1301 is used for processing data units. The communication module 1302 is used for transmitting (sending) and/or receiving data units.

For example, the communication module 1302 may include communication interface(s). The communication module 1302 may be a transceiver module to implement transmitting and/or receiving functions. In this case, the communication module 1302 may be an input/output interface or a transceiver.

In some examples, the first wireless sensing device 110 performs the steps 901 and 903 of the method in the first scenario. In this case, the communication module 1302 performs the step 901, and the processing module 1301 performs the step 903.

In some other examples, the first wireless sensing device 110 performs the steps 1001, 1004 and 1007 of the method in the second scenario. In this case, the communication module 1302 performs the steps 1001 and 1004, and the processing module 1301 performs the step 1007.

In yet some other examples, the first wireless sensing device 110 performs the steps 1101 and 1102 of the method in the third scenario. In this case, the communication module 1302 performs the step 1102, and the processing module 1301 performs the step 1101.

In yet some other examples, the first wireless sensing device 110 performs the steps 1201 to 1203 of the method in the fourth scenario (when the first wireless sensing device is a sensing initiator). In this case, the processing module 1301 performs the step 1201 and the communication module 1302 performs the steps 1202 and 1203. The step 1204 may be performed by the second wireless sensing device 120 as a sensing responder.

In yet some other examples, the first wireless sensing device 110 performs the step 1204 of the method in the fourth scenario (when the first wireless sensing device is a sensing responder). In this case, the processing module 1301 performs the step 1204. The steps 1201 to 1203 may be performed by the second wireless sensing device 120 as a sensing initiator.

It should be noted that, as for the details, reference can be made to the above description, which will not be repeated here.

In some embodiments, the first wireless sensing device 110 further includes a memory module 1303 for storing program instructions and/or data. The processing module 1301 may read the program instructions and/or data stored in the memory module 1303 to implement the method.

It will be noted that, beneficial effects of the first wireless sensing device are same as those of the method for wireless sensing described in some of the above embodiments, and details will not be repeated here.

Some embodiments of the present disclosure provide a second wireless sensing device. The second wireless sensing device is used for performing some steps of the method for wireless sensing as described in the above embodiments/implementations. As shown in FIG. 14, the second wireless sensing device 120 includes a processing module 1401 and a communication module 1402. The processing module 1401 is used for processing data units. The communication module 1402 is used for transmitting (sending) and/or receiving data units.

For example, the communication module 1402 may include communication interface(s). The communication module 1402 may be a transceiver module to implement transmitting and/or receiving functions. In this case, the communication module 1402 may be an input/output interface or a transceiver.

In some examples, the second wireless sensing device 120 performs the step 902 of the method in the first scenario. In this case, the communication module 1402 performs the step 902.

In some other examples, the second wireless sensing device 120 performs the steps 1002, 1003, 1005 and 1006 of the method in the second scenario. In this case, the communication module 1402 performs the steps 1003 and 1006, and the processing module 1401 performs the steps 1002 and 1005.

In yet some other examples, the second wireless sensing device 120 performs the step 1103 of the method in the third scenario. In this case, the processing module 1401 performs the step 1103.

In yet some other examples, the second wireless sensing device 120 performs the step 1204 of the fourth scenario (when the second wireless sensing device is a sensing responder), where the first wireless sensing data unit is discarded. In this case, the processing module 1401 performs the step 1204. The steps 1201 to 1203 may be performed by the first wireless sensing device 110 as a sensing initiator.

In yet some other examples, the second wireless sensing device 120 performs the steps 1201 to 1203 of the method in the fourth scenario (when the second wireless sensing device is a sensing initiator). In this case, the processing module 1401 performs the step 1201 and the communication module 1402 performs the steps 1202 and 1203. The step 1204 may be performed by the first wireless sensing device 110 as a sensing responder.

It should be noted that, as for the details, reference can be made to the above description, which will not be repeated here.

In some embodiments, the second wireless sensing device 120 further includes a memory module 1403 for storing program instructions and/or data. The processing module 1401 may read the program instructions and/or data stored in the memory module 1403 to implement the method.

It will be noted that, beneficial effects of the second wireless sensing device are same as those of the method for wireless sensing described in some of the above embodiments, and details will not be repeated here.

The above embodiments may be implemented in whole or in part through software, hardware, firmware, or any combination thereof. In a case where the above embodiments are implemented by using a software program, the software program may be implemented in whole or in part in a form of a computer program product. The computer program product includes one or more computer instructions. When loaded and executed on a computer, the computer instructions generate some or all of the processes or functions provided in the embodiments of the present disclosure. The computer may be a general-purpose computer, a dedicated computer, a computer network, or any other programmable device. The computer instructions may be stored in a computer-readable storage medium, or transmitted from one computer-readable storage medium to another computer-readable storage medium. For example, the computer instructions may be transmitted from one website site, computer, server or data center to another website site, computer, server or data center through wired (e.g., coaxial cable, optical fiber, digital subscriber line (DSL)) or wireless (e.g., infrared, wireless, microwave) methods. The computer-readable storage medium may be any available medium that may be accessed by the computer, or a server, a data center or any other data storage device including one or more available media. The available medium may be a magnetic medium (e.g., a floppy disk, a magnetic disk or a magnetic tape), an optical medium (e.g., a digital versatile disk (DVD)), a semiconductor medium (e.g., a solid state drive (SSD)), or the like.

From description of the above embodiments, those skilled in the art will clearly understand that, for convenience and brevity of description, an example is only given according to the above division of functional modules. In practical applications, the above functions may be allocated to different functional modules to be completed as needed. That is, an internal structure of a device may be divided into different functional modules to perform all or part of the functions described above. For the specific working process of the above-described system, device, and module, reference may be made to the corresponding process in the foregoing method embodiments, and details will not be repeated here.

In several embodiments provided in the present disclosure, it will be understood that the disclosed systems, devices and methods may be implemented through other manners. For example, the device embodiments described above are merely exemplary. For example, the division of the functional modules is only a logical functional division. In actual implementation, there may be other division manners. For example, in some embodiments, a plurality of devices or components may be combined or integrated into another system, or some features may be ignored or not executed. In addition, the mutual coupling or direct coupling or communication connection shown or discussed may be an indirect coupling or communication connection through some interfaces, devices or modules, and may be an electrical connection, a mechanical connection or other forms of connections.

The modules described as separate components may or may not be physically separated, and the components shown as modules may or may not be physical modules. That is, they may be located in one place, or may be distributed to multiple network modules. Some or all of the modules may be selected according to practical needs to achieve the purposes of the solutions in the embodiments.

The functional modules in the embodiments of the present disclosure may be integrated into a single processing module; or, the modules may be separate physical modules; or, two or more modules may be integrated into a single module. The integrated module may be implemented in the form of hardware, or may be implemented in the form of software functional module.

If the integrated module is implemented in the form of software functional module and sold or used as an independent product, it may be stored in a readable storage medium. Based on this understanding, the technical solution of the present disclosure, in essence, or all or part of the technical solution, may be embodied in the form of a software product. The computer software product is stored in a storage medium, and includes several instructions to cause a computer device (which may be a personal computer, a server, or a network device, etc.) or a processor to execute all or part of the steps of the methods described in various embodiments of the present disclosure. The storage medium includes various types of medium capable of storing program code, such as a USB such as a flash memory, a portable hard disk, a read-only memory (ROM), a random-access memory (RAM), a magnetic disk, or an optical disk.

Some embodiments of the present disclosure provide a computer-readable storage medium (e.g., a non-transitory computer-readable storage medium). The computer-readable storage medium has stored thereon program instructions that, when executed by a first wireless sensing device/second wireless sensing device, cause the first wireless sensing device/second wireless sensing device to execute one or more steps of the method for wireless sensing as described in any one of the above embodiments.

For example, the computer-readable storage medium includes, but is not limited to, a magnetic storage device (e.g., a hard disk, a floppy disk or a magnetic tape), an optical disk (e.g., a compact disk (CD), or a DVD), a smart card, and a flash memory device (e.g., an erasable programmable read-only memory (EPROM), a card, a stick or a key driver). Various computer-readable storage media described in the embodiments of the present disclosure may represent one or more devices and/or other machine-readable storage media, which are used for storing information. The term “computer-readable storage medium” may include, but is not limited to, wireless channels and various other media capable of storing, containing and/or carrying instructions and/or data.

Some embodiments of the present disclosure further provide a computer program product. The computer program product includes program instructions carried on a non-transitory computer-readable storage medium. When executed by a first wireless sensing device/second wireless sensing device, the computer program instructions cause the first wireless sensing device/second wireless sensing device to perform one or more steps of the method for wireless sensing as described in the above embodiments.

Beneficial effects of the computer-readable storage medium and the computer program product are the same as the beneficial effects of the method for wireless sensing as described in some of the above embodiments, and details will not be repeated here.

The foregoing descriptions are merely specific implementations of the present disclosure, but the protection scope of the present disclosure is not limited thereto. Any changes or replacements within the technical scope of the present disclosure shall be included in the protection scope of the present disclosure. Therefore, the protection scope of the present disclosure shall be subject to the protection scope of the claims.

What is claimed is:

1. A method, performed by a first wireless sensing device, the method comprising:
sending a second wireless sensing data unit to a second wireless sensing device, wherein a value of a receiving address field in the second wireless sensing data unit is an address of the second wireless sensing device, and a value of a transmitting address field in the second wireless sensing data unit is an address of the first wireless sensing device;
receiving a first wireless sensing data unit from the second wireless sensing device, wherein a value of the receiving address field and a value of the transmitting address field in the first wireless sensing data unit are the same as the value of the receiving address field and the value of the transmitting address field in the second wireless sensing data unit, respectively; and
discarding the first wireless sensing data unit based on the value of the receiving address field in the first wireless sensing data unit.

2. The method of claim 1, wherein a first value of a field for channel state information (CSI) estimation in the first wireless sensing data unit is different from a second value of the field for the CSI estimation in the second wireless sensing data unit.

3. The method of claim 2, wherein:
the first value is determined based on a first parameter, and the first parameter is used to influence a value of a baseband signal for the CSI estimation; and
the second value is determined based on a predefined second parameter that is used to obtain the baseband signal, and the second parameter is different from the first parameter.

4. The method of claim 3, wherein:
the first parameter includes a first random spatial mapping matrix or a first random channel estimation sequence; and
the second parameter includes a second spatial mapping matrix that is different from the first spatial mapping matrix or a second channel estimation sequence that is different from the first channel estimation sequence.

5. The method of claim 1, wherein:
the first wireless sensing data unit is transmitted by the second wireless sensing device via a set of second antennas with a second antenna radiation pattern that is selected from a set of radiation patterns; and
the second wireless sensing data unit is transmitted by the first wireless sensing device via a set of first antennas with a predefined first antenna radiation pattern.

6. The method of claim 1, wherein:
the first wireless sensing device is a sensing initiator initiating a sensing procedure, and the second wireless sensing device is a sensing responder participating in the sensing procedure; or
the second wireless sensing device is the sensing initiator initiating the sensing procedure, and the first wireless sensing device is the sensing responder participating in the sensing procedure.

7. A wireless sensing device comprising:
one or more processors and a computer-readable memory, wherein instructions are stored on the computer-readable memory that, when executed by the one or more processors, cause the wireless sensing device to perform operations, the operations comprising:
sending a second wireless sensing data unit to a second wireless sensing device, wherein a value of a receiving address field in the second wireless sensing data unit is an address of the second wireless sensing device, and a value of a transmitting address field in the second wireless sensing data unit is an address of the wireless sensing device;
receiving a first wireless sensing data unit from the second wireless sensing device, wherein a value of the receiving address field and a value of the transmitting address field in the first wireless sensing data unit are the same as the value of the receiving address field and the value of the transmitting address field in the second wireless sensing data unit, respectively; and
discarding the first wireless sensing data unit based on the value of the receiving address field in the first wireless sensing data unit.

8. The device of claim 7, wherein a first value of a field for channel state information (CSI) estimation in the first wireless sensing data unit is different from a second value of the field for the CSI estimation in the second wireless sensing data unit.

9. The device of claim 8, wherein:
the first value is determined based on a first parameter, and the first parameter is used to influence a value of a baseband signal for the CSI estimation; and
the second value is determined based on a predefined second parameter that is used to obtain the baseband signal, and the second parameter is different from the first parameter.

10. The device of claim 9, wherein:
the first parameter includes a first random spatial mapping matrix or a first random channel estimation sequence; and
the second parameter includes a second spatial mapping matrix that is different from the first spatial mapping matrix or a second channel estimation sequence that is different from the first channel estimation sequence.

11. The device of claim 7, wherein:
the first wireless sensing data unit is transmitted by the second wireless sensing device via a set of second antennas with a second antenna radiation pattern that is selected from a set of radiation patterns; and
the second wireless sensing data unit is transmitted by the wireless sensing device via a set of first antennas with a predefined first antenna radiation pattern.

12. The device of claim 7, wherein:
the wireless sensing device is a sensing initiator initiating a sensing procedure, and the second wireless sensing device is a sensing responder participating in the sensing procedure; or
the second wireless sensing device is the sensing initiator initiating the sensing procedure, and the wireless sensing device is the sensing responder participating in the sensing procedure.

13. A wireless sensing device comprising:
one or more processors and a computer-readable memory, wherein instructions are stored on the computer-readable memory that, when executed by the one or more processors, cause the wireless sensing device to perform operations, the operations comprising:
receiving a second wireless sensing data unit from a first wireless sensing device, wherein a value of a receiving address field in the second wireless sensing data unit is an address of the wireless sensing device, and a value of a transmitting address field in the second wireless sensing data unit is an address of the first wireless sensing device; and
sending a first wireless sensing data unit, wherein a value of the receiving address field and a value of the transmitting address field in the first wireless sensing data unit are the same as the value of the receiving address field and the value of the transmitting address field in the second wireless sensing data unit, respectively.

14. The device of claim 13, wherein a first value of a field for channel state information (CSI) estimation in the first wireless sensing data unit is different from a second value of the field for the CSI estimation in the second wireless sensing data unit.

15. The device of claim 14, wherein:
the first value is determined based on a first parameter, and the first parameter is used to influence a value of a baseband signal for the CSI estimation; and
the second value is determined based on a predefined second parameter that is used to obtain the baseband signal, and the second parameter is different from the first parameter.

16. The device of claim 15, wherein:
the first parameter includes a first random spatial mapping matrix or a first random channel estimation sequence; and
the second parameter includes a second spatial mapping matrix that is different from the first spatial mapping matrix or a second channel estimation sequence that is different from the first channel estimation sequence.

17. The device of claim 13, wherein:
the first wireless sensing data unit is transmitted by the wireless sensing device via a set of second antennas with a second antenna radiation pattern that is selected from a set of radiation patterns; and
the second wireless sensing data unit is transmitted by the first wireless sensing device via a set of first antennas with a predefined first antenna radiation pattern.

18. The device of claim 13, wherein the first wireless sensing device is a sensing initiator initiating a sensing procedure, and the wireless sensing device is a sensing responder participating in the sensing procedure.

19. The device of claim 13, wherein the wireless sensing device is the sensing initiator initiating the sensing procedure, and the first wireless sensing device is the sensing responder participating in the sensing procedure.

20. The device of claim 16, wherein:
the first parameter includes a first random spatial mapping matrix and a first random channel estimation sequence; and
the second parameter includes a second spatial mapping matrix that is different from the first spatial mapping matrix and a second channel estimation sequence that is different from the first channel estimation sequence.
